(19) United States
(12) Patent Application Publication
(10) Pub. No.: US 2021/0325683 A1
(43) Pub. Date: Oct. 21, 2021

(54) VIRTUAL REALITY SYSTEMS AND METHODS

(71) Applicant: Facebook Technologies, LLC, Menlo Park, CA (US)

(72) Inventors: Christina Yee, Redmond, CA (US); Jeffrey Taylor Stellman, Seattle, WA (US); Clare Regimbal Long, Edmond, WA (US); Joaquin Andres Fierro, Los Gatos, CA (US); Kevin Keeler, El Granada, CA (US); Mark Shriver, Bainbridge Island, WA (US); Andrew Matthew Bardagjy, Seattle, WA (US); Adam Hewko, Kirkland, WA (US); Heya Hewko, West Lafayette, IN (US); Balaji Chelladurai, Bellevue, WA (US); Jian Zhang, San Jose, CA (US); Daniel Meer, Seattle, WA (US); Fabio Stefanini, New York, NY (US); Stephen Mark Jeapes, Cambridge (GB)

(21) Appl. No.: 17/335,801

(22) Filed: Jun. 1, 2021

Related U.S. Application Data
(60) Provisional application No. 63/120,452, filed on Dec. 2, 2020.
(60) Provisional application No. 63/073,795, filed on Sep. 2, 2020.
(60) Provisional application No. 63/111,854, filed on Nov. 10, 2020.
(60) Provisional application No. 63/132,235, filed on Dec. 30, 2020.
(60) Provisional application No. 63/152,813, filed on Feb. 23, 2021.

(51) Int. Cl. G02B 27/01; G02B 27/00; G06F 3/01

(52) U.S. Cl. CPC G02B 27/0176; G02B 27/0172; G02B 27/0093; G02B 2027/0163; G02B 2027/0178; G02B 2027/014; G06F 3/014

(57) ABSTRACT

The disclosed systems and methods may include an example assembly for isolating an inertial measurement unit, for example, in the case of a virtual reality system. Additionally, an example system may include shock-absorbing devices, for example for head-mounted displays. In some examples, the disclosed systems and methods may include a form-in-place gasket for water ingress protection around a flexible printed circuit board. The disclosed systems may also include a system for enhancing remote or virtual social experiences using biosignals. The disclosed systems may additionally include a split device with identity fixed to physical location. Various other related methods and systems are also disclosed.

### CROSS REFERENCE TO RELATED APPLICATION

This application claims the benefits of U.S. Provisional Application No. 63/120,452, filed Dec. 2, 2020, U.S. Provisional Application No. 63/073,795, filed Sep. 2, 2020, U.S. Provisional Application No. 63/111,854, filed Nov. 10, 2020, U.S. Provisional Application No. 63/132,235, filed Dec. 30, 2020, and U.S. Provisional Application No. 63/152,813, filed Feb. 23, 2021, the disclosures of each of which are incorporated, in their entirety, by this reference.

### BRIEF DESCRIPTION OF DRAWINGS

The accompanying drawings illustrate a number of exemplary embodiments and are a part of the specification. Together with the following description, these drawings demonstrate and explain various principles of the present disclosure.

FIG. 1 is an illustration of exemplary augmented-reality glasses that may be used in connection with embodiments of this disclosure.

FIG. 2 is an illustration of an exemplary virtual-reality headset that may be used in connection with embodiments of this disclosure.

FIG. 3 is an illustration of an exemplary system for isolating an IMU that may be used in connection with embodiments of this disclosure.

FIG. 4 is an illustration of a perspective view of the system for isolating an IMU that may be used in connection with embodiments of this disclosure.

FIG. 5 is an illustration of a cross-sectional side view of the system for isolating an IMU that may be used in connection with embodiments of this disclosure.

FIG. 6 is a table including examples of isolation assembly configurations and materials.

FIG. 7 illustrates an example head-mounted display with integrated image sensors, according to at least one embodiment of the present disclosure.

FIG. 8 is a cross-sectional view of an example image sensor, according to at least one embodiment of the present disclosure.

FIG. 9 is another cross-sectional view of an example image sensor, according to at least one embodiment of the present disclosure.

FIG. 10 is a plan view of an example image sensor, according to at least one embodiment of the present disclosure.

FIG. 11 is a perspective view of an example image sensor, according to at least one embodiment of the present disclosure.

FIG. 12 is an illustration of example haptic devices that may be used in connection with embodiments of this disclosure.

FIG. 13 is an illustration of an example virtual-reality environment according to embodiments of this disclosure.

FIG. 14 is an illustration of an example augmented-reality environment according to embodiments of this disclosure.

FIG. 15 is an illustration of an example top view of a gasket placed over a section of a flexible printed circuit board.

FIG. 16 is an illustration of an example top view of a flexible printed circuit board that shows wings included in a section of the flexible printed circuit board that may be enclosed by a gasket.

FIG. 17 is an illustration of an example top view of a molding fixture showing a section of a flexible printed circuit board placed inside of the molding fixture.

FIG. 18 is an illustration of an example cross-sectional side view of a section of a flexible printed circuit board enclosed by a gasket and incorporated into an enclosure of a device.

FIG. 19 is an illustration of an example wearable electronic device.

FIG. 20 is a schematic diagram of components of an exemplary biosignal sensing system in accordance with some embodiments of the technology described herein.

FIG. 21 is a block diagram of an exemplary system for enhancing remote or virtual social experiences using biosignals.

FIG. 22 is a flow diagram of an exemplary computer-implemented method for enhancing remote or virtual social experiences using biosignals.

FIG. 23 is a sequence diagram of an exemplary system for enhancing remote or virtual social experiences using biosignals.

FIG. 24 is a diagram of an exemplary virtual object being simultaneously interacted with by two users.

FIG. 25A is a block diagram of an exemplary system for a split device with identity fixed to a physical location.

FIG. 25B is a block diagram of the exemplary system of FIG. 25A mounted with a configurable device.

FIG. 25C is a block diagram of the exemplary system of FIG. 25A mounted with the configurable device removed.

FIG. 25D is a block diagram of the exemplary system of FIG. 25A mounted with a replacement device.

FIG. 26 is a flow diagram of an exemplary method for using a split device with identity fixed to a physical location.

FIGS. 27-39B provide examples of accelerometer readings showing results both with and without the IMU isolation assembly.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION

Example Assembly for Isolating an Inertial Measurement Unit (IMU)

Many conventional artificial-reality systems include a headset that uses video and audio to aid in augmenting a user's perception of reality or for immersing a user in an artificial-reality experience. Often, a traditional artificial-reality headset will include speakers coupled to or otherwise integrated with the headset. In order to track rotational movements, angular rate, and acceleration (to maintain a user's position, point of view, and the like in an artificial-reality world for example), conventional artificial-reality headsets may include a sensor such as an inertial measurement unit (IMU). Traditional artificial-reality headsets will typically have the IMU coupled to the headset to obtain relevant accelerometer and gyroscopic data and aid in presenting artificial-reality worlds and augmented scenarios to a user.

Being in proximity to the speakers, however, may introduce interference with the IMU's readings and cause inaccuracies in the IMU data, especially with high audio volume levels. The effects of this interference could include gyroscope drift, in which the initial position, or zero reading of the IMU changes over time. As a result, the user's virtual experience is impacted as sound, video, and even haptic feedback may be inaccurately conveyed to the user.

The present disclosure is generally directed to an assembly for isolating an IMU from vibrations that would otherwise cause gyroscopic drift. The IMU may therefore still be located on the headset near the cameras, speakers, and other equipment where the IMU can collect the most relevant data without much of the inference caused by surrounding components.

Embodiments of the present disclosure may include or be implemented in conjunction with various types of artificial reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

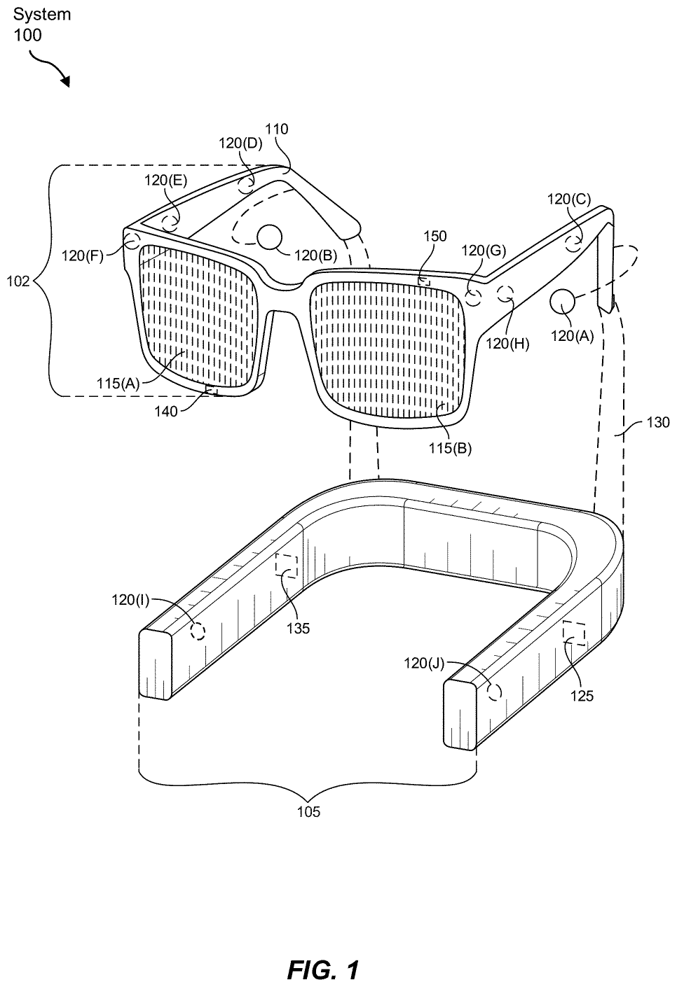

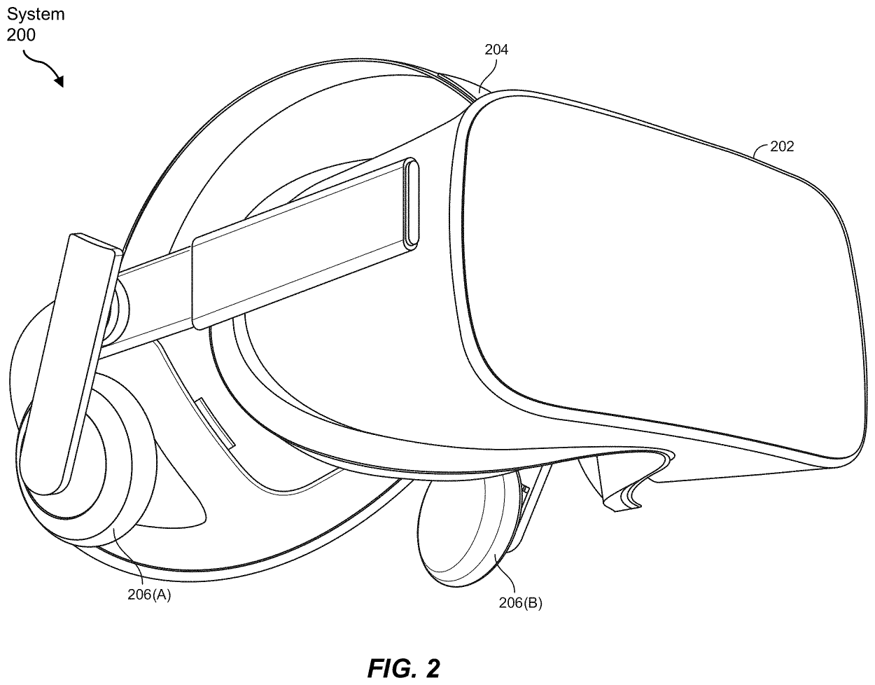

Artificial-reality systems may be implemented in a variety of different form factors and configurations. Some artificial reality systems may be designed to work without near-eye displays (NEDs). Other artificial reality systems may include an NED that also provides visibility into the real world (such as, e.g., augmented-reality system 100 in FIG. 1) or that visually immerses a user in an artificial reality (such as, e.g., virtual-reality system 200 in FIG. 2). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 1, augmented-reality system 100 may include an eyewear device 102 with a frame 110 configured to hold a left display device 115(A) and a right display device 115(B) in front of a user's eyes. Display devices 115(A) and 115(B) may act together or independently to present an image or series of images to a user. While augmented-reality system 100 includes two displays, embodiments of this disclosure may be implemented in augmented-reality systems with a single NED or more than two NEDs.

In some embodiments, augmented-reality system 100 may include one or more sensors, such as sensor 140. Sensor 140 may generate measurement signals in response to motion of augmented-reality system 100 and may be located on substantially any portion of frame 110. Sensor 140 may represent one or more of a variety of different sensing mechanisms, such as a position sensor, an inertial measurement unit (IMU), a depth camera assembly, a structured light emitter and/or detector, or any combination thereof. In some embodiments, augmented-reality system 100 may or may not include sensor 140 or may include more than one sensor. In embodiments in which sensor 140 includes an IMU, the IMU may generate calibration data based on measurement signals from sensor 140. Examples of sensor 140 may include, without limitation, accelerometers, gyroscopes, magnetometers, other suitable types of sensors that detect motion, sensors used for error correction of the IMU, or some combination thereof.

In some examples, augmented-reality system 100 may also include a microphone array with a plurality of acoustic transducers 120(A)-120(J), referred to collectively as acoustic transducers 120. Acoustic transducers 120 may represent transducers that detect air pressure variations induced by sound waves. Each acoustic transducer 120 may be configured to detect sound and convert the detected sound into an electronic format (e.g., an analog or digital format). The microphone array in FIG. 1 may include, for example, ten acoustic transducers: 120(A) and 120(B), which may be designed to be placed inside a corresponding ear of the user, acoustic transducers 120(C), 120(D), 120(E), 120(F), 120(G), and 120(H), which may be positioned at various locations on frame 110, and/or acoustic transducers 120(I) and 120(J), which may be positioned on a corresponding neckband 105.

In some embodiments, one or more of acoustic transducers 120(A)-(J) may be used as output transducers (e.g., speakers). For example, acoustic transducers 120(A) and/or 120(B) may be earbuds or any other suitable type of headphone or speaker.

The configuration of acoustic transducers 120 of the microphone array may vary. While augmented-reality system 100 is shown in FIG. 1 as having ten acoustic transducers 120, the number of acoustic transducers 120 may be greater or less than ten. In some embodiments, using higher numbers of acoustic transducers 120 may increase the amount of audio information collected and/or the sensitivity and accuracy of the audio information. In contrast, using a lower number of acoustic transducers 120 may decrease the computing power required by an associated controller 150 to process the collected audio information. In addition, the position of each acoustic transducer 120 of the microphone array may vary. For example, the position of an acoustic transducer 120 may include a defined position on the user, a defined coordinate on frame 110, an orientation associated with each acoustic transducer 120, or some combination thereof.

Acoustic transducers 120(A) and 120(B) may be positioned on different parts of the user's ear, such as behind the pinna, behind the tragus, and/or within the auricle or fossa. Or, there may be additional acoustic transducers 120 on or surrounding the ear in addition to acoustic transducers 120 inside the ear canal. Having an acoustic transducer 120 positioned next to an ear canal of a user may enable the microphone array to collect information on how sounds arrive at the ear canal. By positioning at least two of acoustic transducers 120 on either side of a user's head (e.g., as binaural microphones), augmented-reality device 100 may simulate binaural hearing and capture a 3D stereo sound field around about a user's head. In some embodiments, acoustic transducers 120(A) and 120(B) may be connected to augmented-reality system 100 via a wired connection 130, and in other embodiments acoustic transducers 120(A) and 120(B) may be connected to augmented-reality system 100 via a wireless connection (e.g., a Bluetooth connection). In still other embodiments, acoustic transducers 120(A) and 120(B) may not be used at all in conjunction with augmented-reality system 100.

Acoustic transducers 120 on frame 110 may be positioned in a variety of different ways, including along the length of the temples, across the bridge, above or below display devices 115(A) and 115(B), or some combination thereof. Acoustic transducers 120 may also be oriented such that the microphone array is able to detect sounds in a wide range of directions surrounding the user wearing the augmented-reality system 100. In some embodiments, an optimization process may be performed during manufacturing of augmented-reality system 100 to determine relative positioning of each acoustic transducer 120 in the microphone array.

In some examples, augmented-reality system 100 may include or be connected to an external device (e.g., a paired device), such as neckband 105. Neckband 105 generally represents any type or form of paired device. Thus, the following discussion of neckband 105 may also apply to various other paired devices, such as charging cases, smart watches, smart phones, wrist bands, other wearable devices, hand-held controllers, tablet computers, laptop computers, other external compute devices, etc.

As shown, neckband 105 may be coupled to eyewear device 102 via one or more connectors. The connectors may be wired or wireless and may include electrical and/or non-electrical (e.g., structural) components. In some cases, eyewear device 102 and neckband 105 may operate independently without any wired or wireless connection between them. While FIG. 1 illustrates the components of eyewear device 102 and neckband 105 in example locations on eyewear device 102 and neckband 105, the components may be located elsewhere and/or distributed differently on eyewear device 102 and/or neckband 105. In some embodiments, the components of eyewear device 102 and neckband 105 may be located on one or more additional peripheral devices paired with eyewear device 102, neckband 105, or some combination thereof.

Pairing external devices, such as neckband 105, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 100 may be provided by a paired device or shared between a paired device and an eyewear device, thus reducing the weight, heat profile, and form factor of the eyewear device overall while still retaining desired functionality. For example, neckband 105 may allow components that would otherwise be included on an eyewear device to be included in neckband 105 since users may tolerate a heavier weight load on their shoulders than they would tolerate on their heads. Neckband 105 may also have a larger surface area over which to diffuse and disperse heat to the ambient environment. Thus, neckband 105 may allow for greater battery and computation capacity than might otherwise have been possible on a stand-alone eyewear device. Since weight carried in neckband 105 may be less invasive to a user than weight carried in eyewear device 102, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 105 may be communicatively coupled with eyewear device 102 and/or to other devices. These other devices may provide certain functions (e.g., tracking, localizing, depth mapping, processing, storage, etc.) to augmented-reality system 100. In the embodiment of FIG. 1, neckband 105 may include two acoustic transducers (e.g., 120(I) and 120(J)) that are part of the microphone array (or potentially form their own microphone subarray). Neckband 105 may also include a controller 125 and a power source 135.

Acoustic transducers 120(I) and 120(J) of neckband 105 may be configured to detect sound and convert the detected sound into an electronic format (analog or digital). In the embodiment of FIG. 1, acoustic transducers 120(I) and 120(J) may be positioned on neckband 105, thereby increasing the distance between the neckband acoustic transducers 120(I) and 120(J) and other acoustic transducers 120 positioned on eyewear device 102. In some cases, increasing the distance between acoustic transducers 120 of the microphone array may improve the accuracy of beamforming performed via the microphone array. For example, if a sound is detected by acoustic transducers 120(C) and 120(D) and the distance between acoustic transducers 120(C) and 120(D) is greater than, e.g., the distance between acoustic transducers 120(D) and 120(E), the determined source location of the detected sound may be more accurate than if the sound had been detected by acoustic transducers 120(D) and 120(E).

Controller 125 of neckband 105 may process information generated by the sensors on neckband 105 and/or augmented-reality system 100. For example, controller 125 may process information from the microphone array that describes sounds detected by the microphone array. For each detected sound, controller 125 may perform a direction-of-arrival (DOA) estimation to estimate a direction from which the detected sound arrived at the microphone array. As the microphone array detects sounds, controller 125 may populate an audio data set with the information. In embodiments in which augmented-reality system 100 includes an inertial measurement unit, controller 125 may compute all inertial and spatial calculations from the IMU located on eyewear device 102. A connector may convey information between augmented-reality system 100 and neckband 105 and between augmented-reality system 100 and controller 125. The information may be in the form of optical data, electrical data, wireless data, or any other transmittable data form. Moving the processing of information generated by augmented-reality system 100 to neckband 105 may reduce weight and heat in eyewear device 102, making it more comfortable to the user.

Power source 135 in neckband 105 may provide power to eyewear device 102 and/or to neckband 105. Power source 135 may include, without limitation, lithium ion batteries, lithium-polymer batteries, primary lithium batteries, alkaline batteries, or any other form of power storage. In some cases, power source 135 may be a wired power source. Including power source 135 on neckband 105 instead of on eyewear device 102 may help better distribute the weight and heat generated by power source 135.

As noted, some artificial reality systems may, instead of blending an artificial reality with actual reality, substantially replace one or more of a user's sensory perceptions of the real world with a virtual experience. One example of this type of system is a head-worn display system, such as virtual-reality system 200 in FIG. 2, that mostly or completely covers a user's field of view. Virtual-reality system 200 may include a front rigid body 202 and a band 204 shaped to fit around a user's head. Virtual-reality system 200 may also include output audio transducers 206(A) and 206(B). Furthermore, while not shown in FIG. 2, front rigid body 202 may include one or more electronic elements, including one or more electronic displays, one or more inertial measurement units (IMUS), one or more tracking emitters or detectors, and/or any other suitable device or system for creating an artificial-reality experience.

Artificial reality systems may include a variety of types of visual feedback mechanisms. For example, display devices in augmented-reality system 100 and/or virtual-reality system 200 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. These artificial reality systems may include a single display screen for both eyes or may provide a display screen for each eye, which may allow for additional flexibility for varifocal adjustments or for correcting a user's refractive error. Some of these artificial reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial reality systems described herein may include one or more projection systems. For example, display devices in augmented-reality system 100 and/or virtual-reality system 200 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial reality systems may also be configured with any other suitable type or form of image projection system, such as retinal projectors used in virtual retina displays.

The artificial reality systems described herein may also include various types of computer vision components and subsystems. For example, augmented-reality system 100 and/or virtual-reality system 200 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

The artificial reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial reality experience in one or more of these contexts and environments and/or in other contexts and environments.

Some augmented-reality systems may map a user's and/or device's environment using techniques referred to as “simultaneous location and mapping” (SLAM). SLAM mapping and location identifying techniques may involve a variety of hardware and software tools that can create or update a map of an environment while simultaneously keeping track of a user's location within the mapped environment. SLAM may use many different types of sensors to create a map and determine a user's position within the map.

SLAM techniques may, for example, implement optical sensors to determine a user's location. Radios including Wi-Fi, Bluetooth, global positioning system (GPS), cellular or other communication devices may be also used to determine a user's location relative to a radio transceiver or group of transceivers (e.g., a Wi-Fi router or group of GPS satellites). Acoustic sensors such as microphone arrays or 2D or 3D sonar sensors may also be used to determine a user's location within an environment. Augmented-reality and virtual-reality devices (such as systems 100 and 200 of FIGS. 1 and 2, respectively) may incorporate any or all of these types of sensors to perform SLAM operations such as creating and continually updating maps of the user's current environment. In at least some of the embodiments described herein, SLAM data generated by these sensors may be referred to as “environmental data” and may indicate a user's current environment. This data may be stored in a local or remote data store (e.g., a cloud data store) and may be provided to a user's AR/VR device on demand.

When the user is wearing an augmented-reality headset or virtual-reality headset in a given environment, the user may be interacting with other users or other electronic devices that serve as audio sources. In some cases, it may be desirable to determine where the audio sources are located relative to the user and then present the audio sources to the user as if they were coming from the location of the audio source. The process of determining where the audio sources are located relative to the user may be referred to as “localization,” and the process of rendering playback of the audio source signal to appear as if it is coming from a specific direction may be referred to as “spatialization.”

Localizing an audio source may be performed in a variety of different ways. In some cases, an augmented-reality or virtual-reality headset may initiate a DOA analysis to determine the location of a sound source. The DOA analysis may include analyzing the intensity, spectra, and/or arrival time of each sound at the artificial-reality device to determine the direction from which the sounds originated. The DOA analysis may include any suitable algorithm for analyzing the surrounding acoustic environment in which the artificial-reality device is located.

For example, the DOA analysis may be designed to receive input signals from a microphone and apply digital signal processing algorithms to the input signals to estimate the direction of arrival. These algorithms may include, for example, delay and sum algorithms where the input signal is sampled, and the resulting weighted and delayed versions of the sampled signal are averaged together to determine a direction of arrival. A least mean squared (LMS) algorithm may also be implemented to create an adaptive filter. This adaptive filter may then be used to identify differences in signal intensity, for example, or differences in time of arrival. These differences may then be used to estimate the direction of arrival. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct-path audio signal. Those bins having a portion of the direct-path signal may then be analyzed to identify the angle at which a microphone array received the direct-path audio signal. The determined angle may then be used to identify the direction of arrival for the received input signal. Other algorithms not listed above may also be used alone or in combination with the above algorithms to determine DOA.

In some embodiments, different users may perceive the source of a sound as coming from slightly different locations. This may be the result of each user having a unique head-related transfer function (HRTF), which may be dictated by a user's anatomy including ear canal length and the positioning of the ear drum. The artificial-reality device may provide an alignment and orientation guide, which the user may follow to customize the sound signal presented to the user based on their unique HRTF. In some embodiments, an artificial-reality device may implement one or more microphones to listen to sounds within the user's environment. The augmented-reality or virtual-reality headset may use a variety of different array transfer functions (e.g., any of the DOA algorithms identified above) to estimate the direction of arrival for the sounds. Once the direction of arrival has been determined, the artificial-reality device may play back sounds to the user according to the user's unique HRTF. Accordingly, the DOA estimation generated using the array transfer function (ATF) may be used to determine the direction from which the sounds are to be played from. The playback sounds may be further refined based on how that specific user hears sounds according to the HRTF.

In addition to or as an alternative to performing a DOA estimation, an artificial-reality device may perform localization based on information received from other types of sensors. These sensors may include cameras, IR sensors, heat sensors, motion sensors, GPS receivers, or in some cases, sensors that detect a user's eye movements. For example, as noted above, an artificial-reality device may include an eye tracker or gaze detector that determines where the user is looking. Often, the user's eyes will look at the source of the sound, if only briefly. Such clues provided by the user's eyes may further aid in determining the location of a sound source. Other sensors such as cameras, heat sensors, and IR sensors may also indicate the location of a user, the location of an electronic device, or the location of another sound source. Any or all of the above methods may be used individually or in combination to determine the location of a sound source and may further be used to update the location of a sound source over time.

Some embodiments may implement the determined DOA to generate a more customized output audio signal for the user. For instance, an “acoustic transfer function” may characterize or define how a sound is received from a given location. More specifically, an acoustic transfer function may define the relationship between parameters of a sound at its source location and the parameters by which the sound signal is detected (e.g., detected by a microphone array or detected by a user's ear). An artificial-reality device may include one or more acoustic sensors that detect sounds within range of the device. A controller of the artificial-reality device may estimate a DOA for the detected sounds (using, e.g., any of the methods identified above) and, based on the parameters of the detected sounds, may generate an acoustic transfer function that is specific to the location of the device. This customized acoustic transfer function may thus be used to generate a spatialized output audio signal where the sound is perceived as coming from a specific location.

Indeed, once the location of the sound source or sources is known, the artificial-reality device may re-render (i.e., spatialize) the sound signals to sound as if coming from the direction of that sound source. The artificial-reality device may apply filters or other digital signal processing that alter the intensity, spectra, or arrival time of the sound signal. The digital signal processing may be applied in such a way that the sound signal is perceived as originating from the determined location. The artificial-reality device may amplify or subdue certain frequencies or change the time that the signal arrives at each ear. In some cases, the artificial-reality device may create an acoustic transfer function that is specific to the location of the device and the detected direction of arrival of the sound signal. In some embodiments, the artificial-reality device may re-render the source signal in a stereo device or multi-speaker device (e.g., a surround sound device). In such cases, separate and distinct audio signals may be sent to each speaker. Each of these audio signals may be altered according to the user's HRTF and according to measurements of the user's location and the location of the sound source to sound as if they are coming from the determined location of the sound source. Accordingly, in this manner, the artificial-reality device (or speakers associated with the device) may re-render an audio signal to sound as if originating from a specific location.

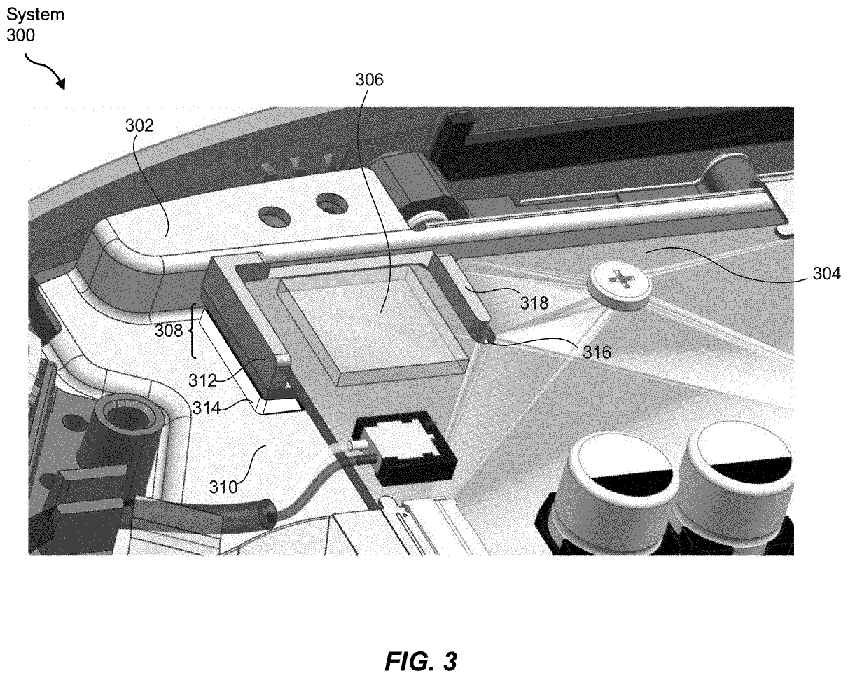

FIG. 3 depicts one embodiment of a system 300 for isolating an IMU. In this example, system 300 isolates the IMU from mechanical and audio vibrations, such as those occurring as a result of high audio volume on headset speakers. FIG. 3 depicts a camera frame 302 or other supporting structure of an augmented-reality system such as the system 100 of FIG. 1 or the system 200 of FIG. 2. For example, the camera frame 302 may be coupled to and/or include a supporting structure for components of the eyewear device 102 of FIG. 1 or the virtual-reality system 200 of FIG. 2. The camera frame 302 may include metal or other rigid material and may include a circuit board coupled to the camera frame 302. Any suitable circuit board may be used such as, for example, a motherboard. FIG. 3 also depicts a motherboard 304 coupled to the camera frame 302 and an IMU 306 coupled to the motherboard 304.

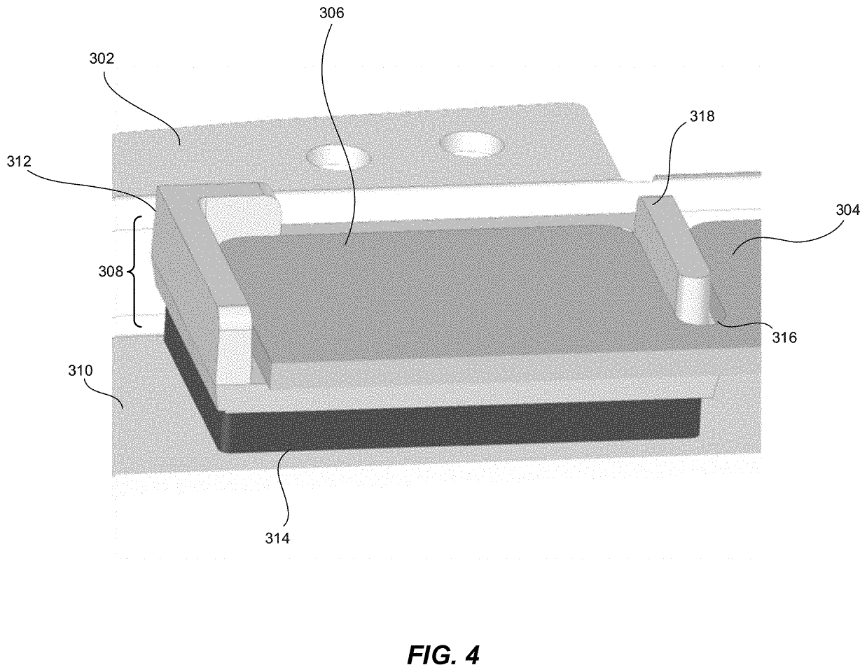

The IMU 306, being coupled to the camera frame 302 via the motherboard 304 as depicted, may be suitably positioned in the system 100 or 200 to generate gyroscopic data but may also be prone to gyroscopic drift due to audio and mechanical vibrations of nearby components such as audio speakers. Therefore, the system 300 includes an isolation assembly 308 disposed between the motherboard 304 and a base surface 310 of the camera frame 302. Referring also to FIG. 4, which shows a perspective view of the system 300, the isolation assembly 308 may be located in a region of the motherboard 304 on which the IMU 306 is coupled (e.g., the depicted embodiment shows the isolation assembly 308 disposed between the motherboard 304 and base surface 310 in a corner of the motherboard 304). The isolation assembly 308 may serve to isolate the IMU 306 from interfering vibrations by, for example, stiffening the nearby region of the motherboard 304 and/or reducing vibrations in at least a portion of the motherboard adjacent to the IMU.

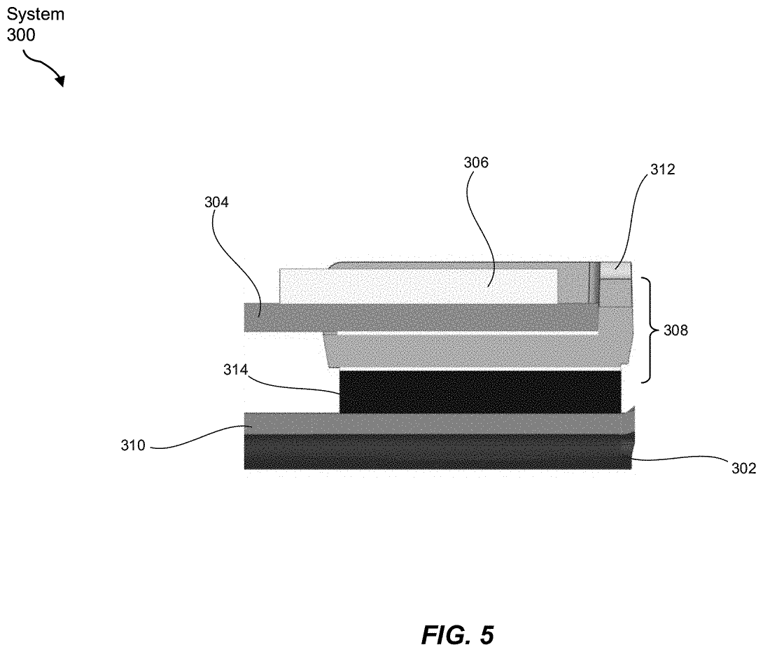

Referring to FIG. 5, which shows a cross sectional side view of the system 300, the isolation assembly 308 may be sandwiched between the motherboard 304 and the camera frame 302. The isolation assembly 308 may be adhered (e.g., using pressure sensitive adhesive) to an underside of the motherboard 304. Referring to FIG. 4 and FIG. 5, in one embodiment, the isolation assembly 308 may include a rigid piece 312. The rigid piece 312 may be adhered (e.g., using pressure sensitive adhesive) to an underside of the motherboard 304. Any suitable rigid piece 312 may be used in a variety of compositions and configurations and in varying degrees of rigidity. Some examples of materials that may be used include, without limitation, plastic, composite or metal. In some examples, as used herein, the term “shim” refers to the rigid piece 312.

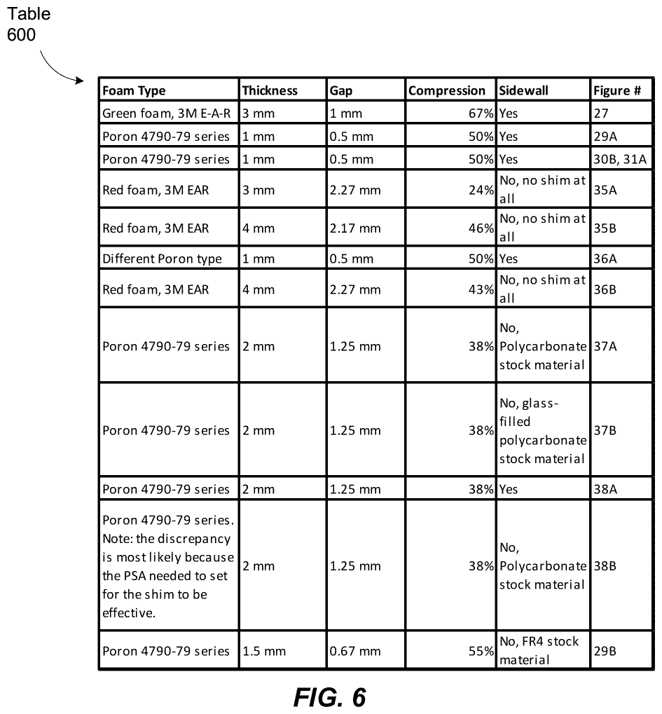

The depicted isolation assembly 308 also includes a compressible foam layer 314 disposed between the rigid piece 312 and the base surface 310 of the camera frame 302 such that the foam layer 314 and the rigid piece 312 are sandwiched between the motherboard 304 and the base surface 310. The foam layer 314 may be compressed against the base surface 310 to further absorb and reduce vibration that could affect the IMU 306. The foam layer 314 may be adhered (e.g., via a pressure sensitive adhesive) to an underside of the rigid piece 312. In certain examples, the foam layer 314 occupies a gap of approximately 1.5 mm maximum between the base surface 310 and the rigid piece 312, although any suitable gap may be used. In other examples, the foam layer 314 may be approximately 1 mm in height with approximately 50% compression. Although the depicted isolation assembly 308 includes both a rigid piece 312 and a foam layer 314, in other embodiments, the isolation assembly 308 may include a foam layer 314 alone. Any suitable material and configuration may be used for the foam layer 314. Because certain foams may dampen noise at targeted frequencies, a type of foam may be selected depending on the desired frequencies to target. The foam may have, in some examples, an open and/or closed cell structure. Some examples of foam materials may include, without limitation, polyurethane foams (e.g., polyurethane foams sold under the trademark PORON® from Rogers Corporation, polyurethane foams sold under the trademark E-A-R™ from 3M Corporation, polyurethane foams sold by General Plastics Manufacturing Company, etc.). Example materials and configurations of the isolation assembly will be referenced below in a detailed description of FIG. 6.

Referring back to FIG. 3 and FIG. 4, in the depicted embodiment, the motherboard 304 includes a slot 316 to allow the rigid piece 312 to partially surround the IMU 306 by way of a protruding sidewall 318 positioned in the slot 316 of the motherboard 304. Although the depicted embodiment of the rigid piece 312 includes a protruding sidewall 318, in certain examples, the rigid piece 312 lacks a sidewall. Furthermore, the depicted embodiment has a single protruding sidewall 318; however, in other embodiments, the rigid piece 312 may include one or more other protruding sidewalls 318 extending along peripheral edges of portions of the motherboard 304. In some examples, to achieve the desired rigidity while minimizing or eliminating the use of sidewalls, a more rigid material for the rigid piece 312 may be used.

The isolation assembly 308 may serve to locally isolate and stiffen an area of the motherboard 304 around the IMU 306, putting the resonance and vibration frequencies of the IMU 306, caused by, for example, audio from nearby speakers, out of the IMU frequency recording range used for tracking and data acquisition purposes. This may improve the functional quality of the augmented-reality system 100 or virtual-reality system 200 and improve the user experience.

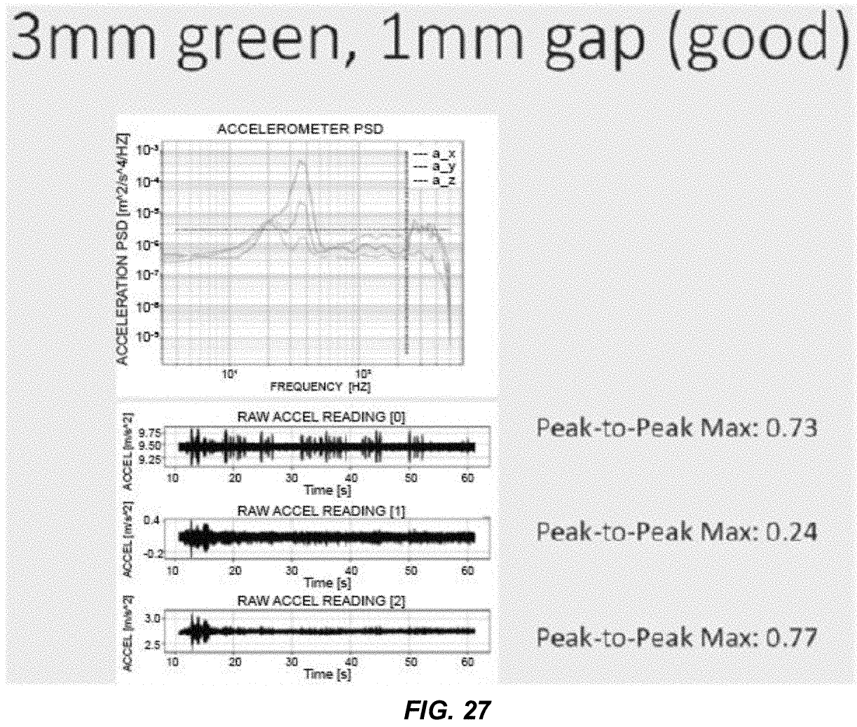

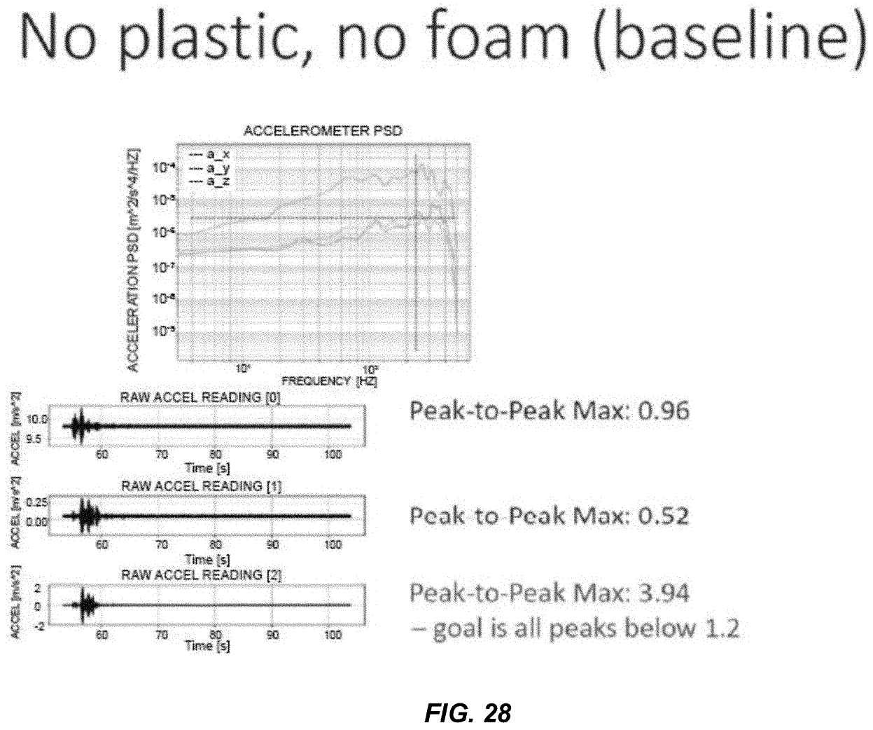

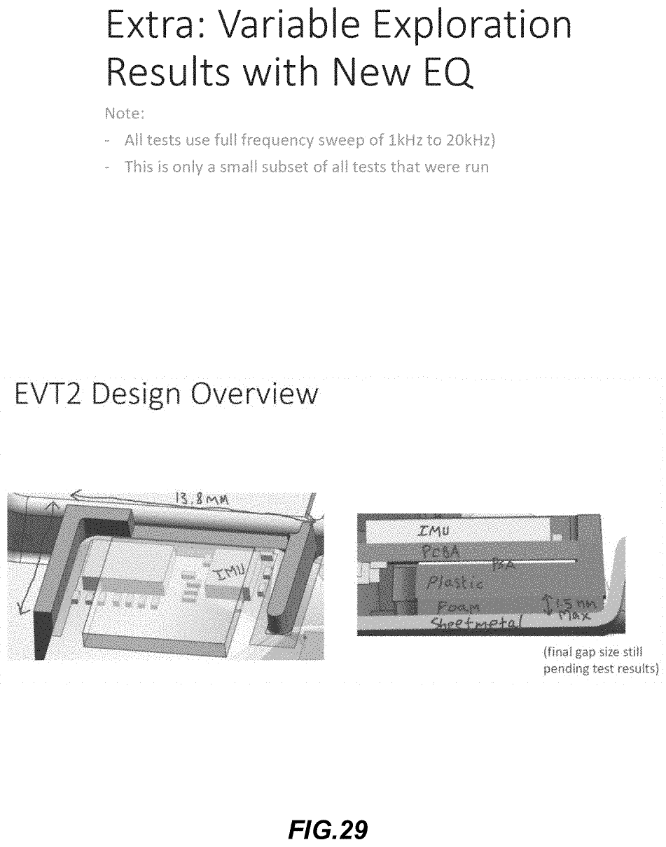

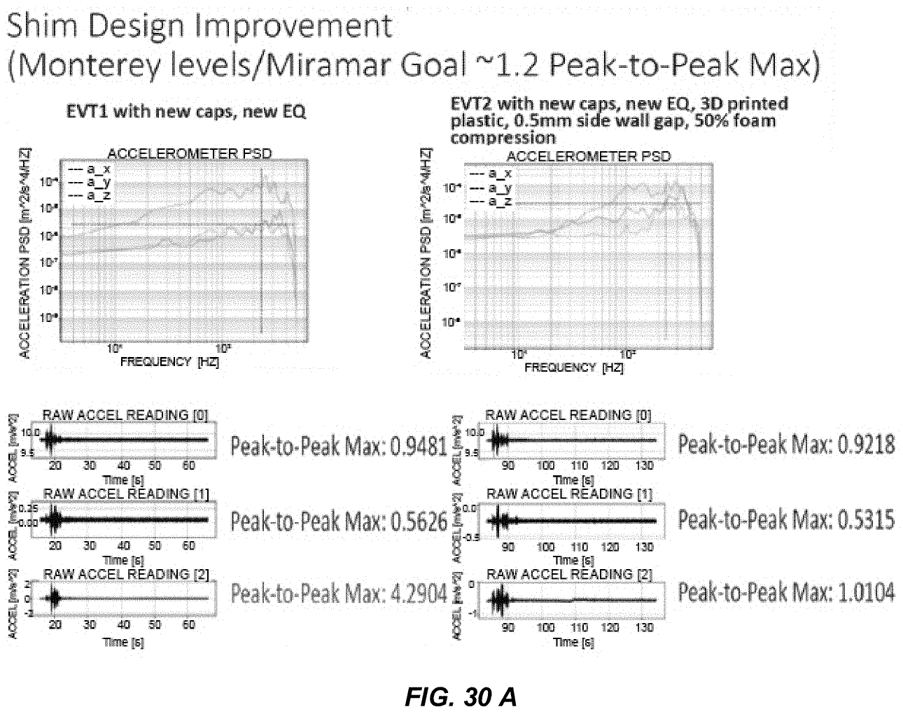

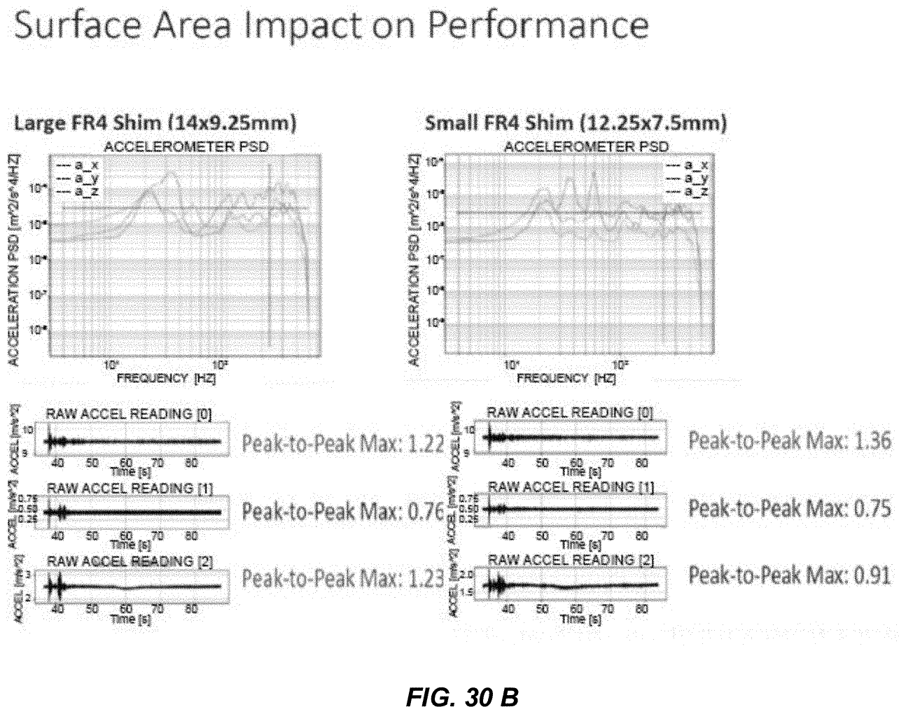

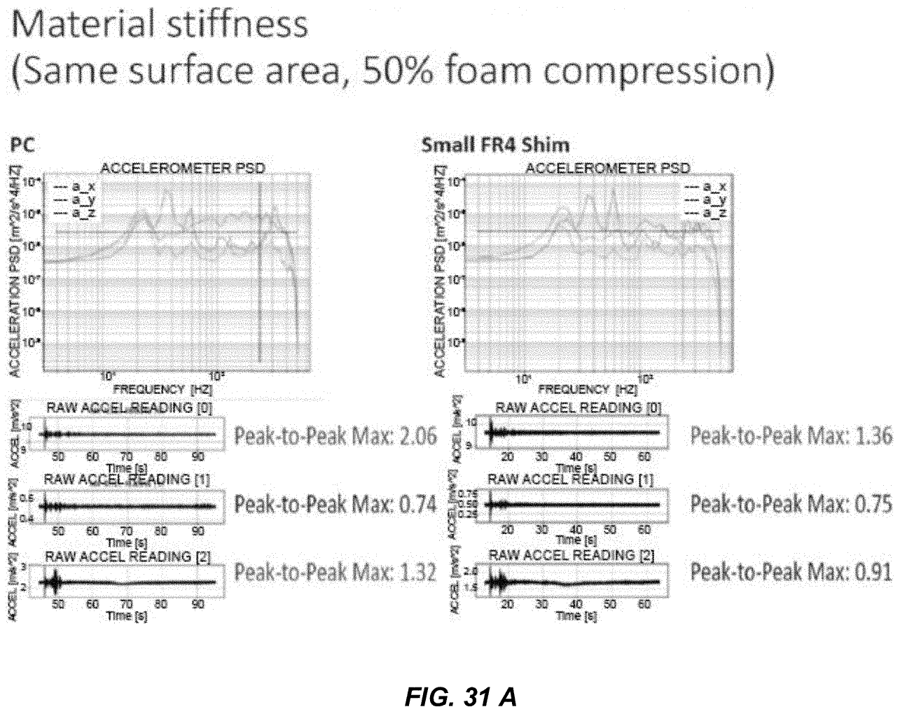

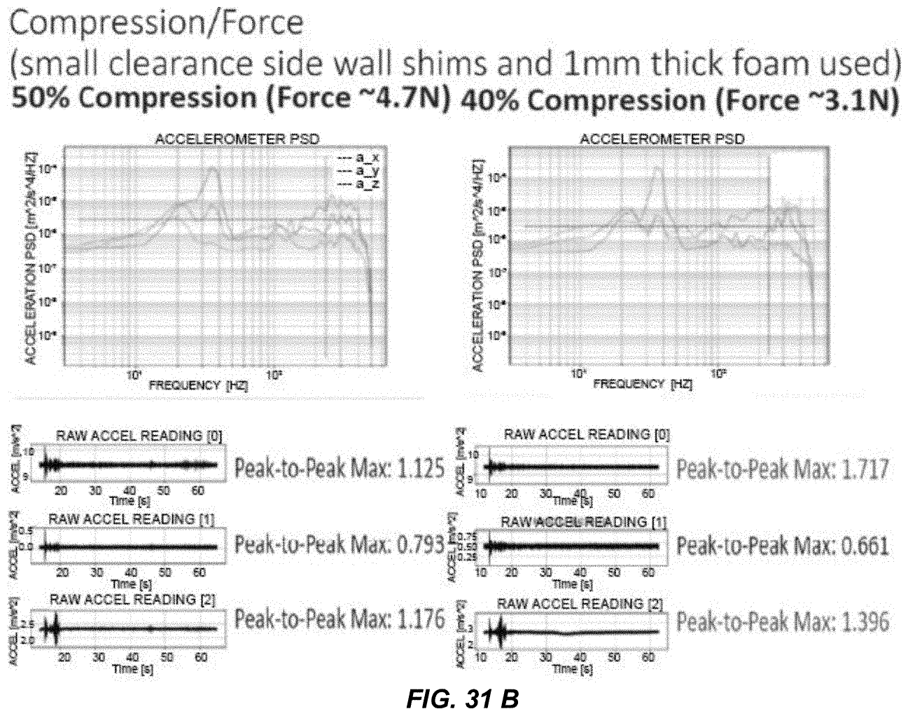

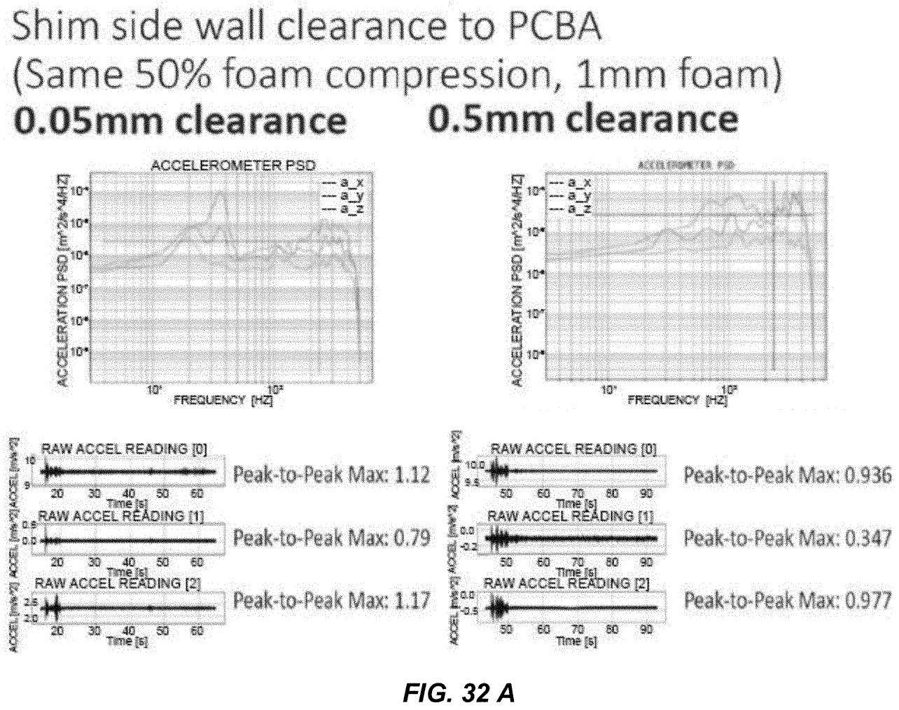

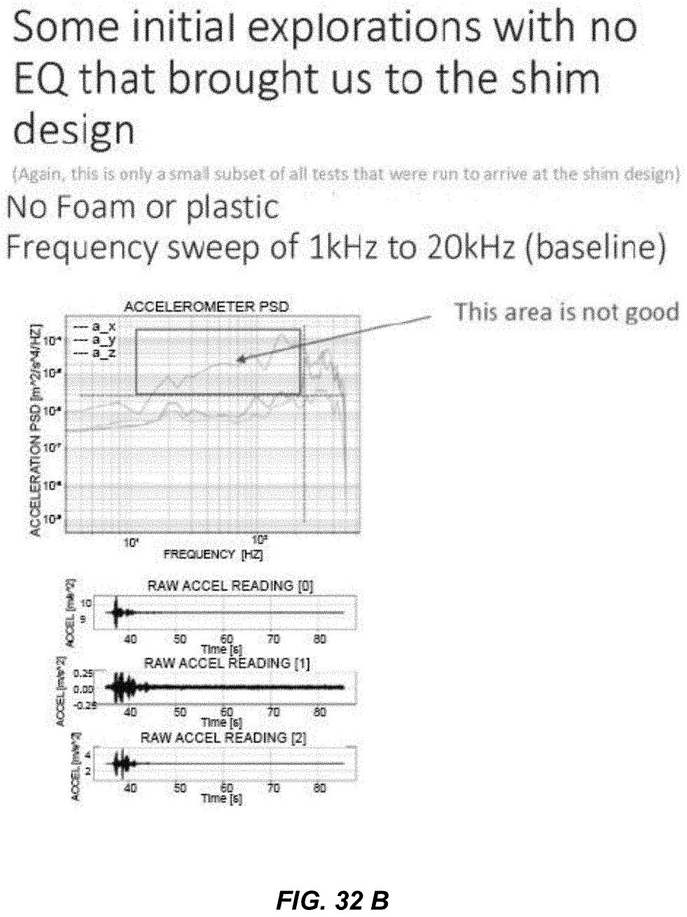

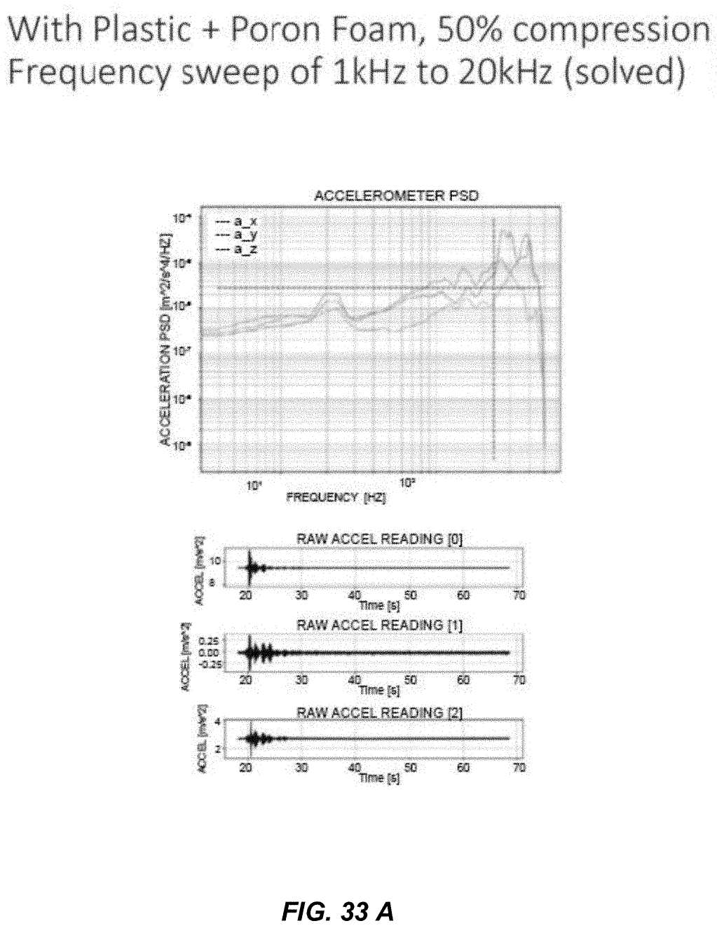

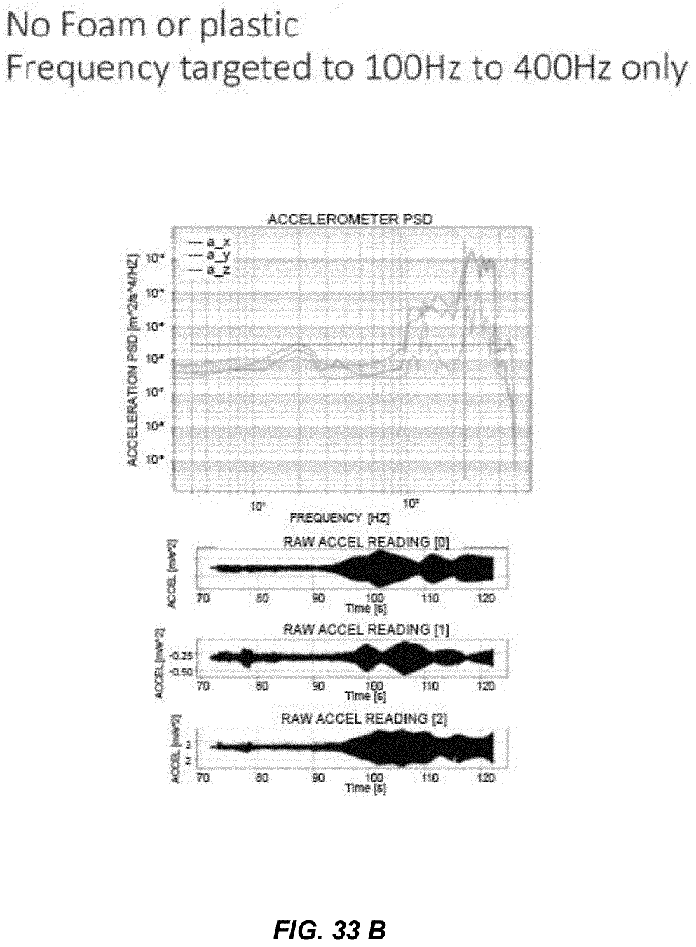

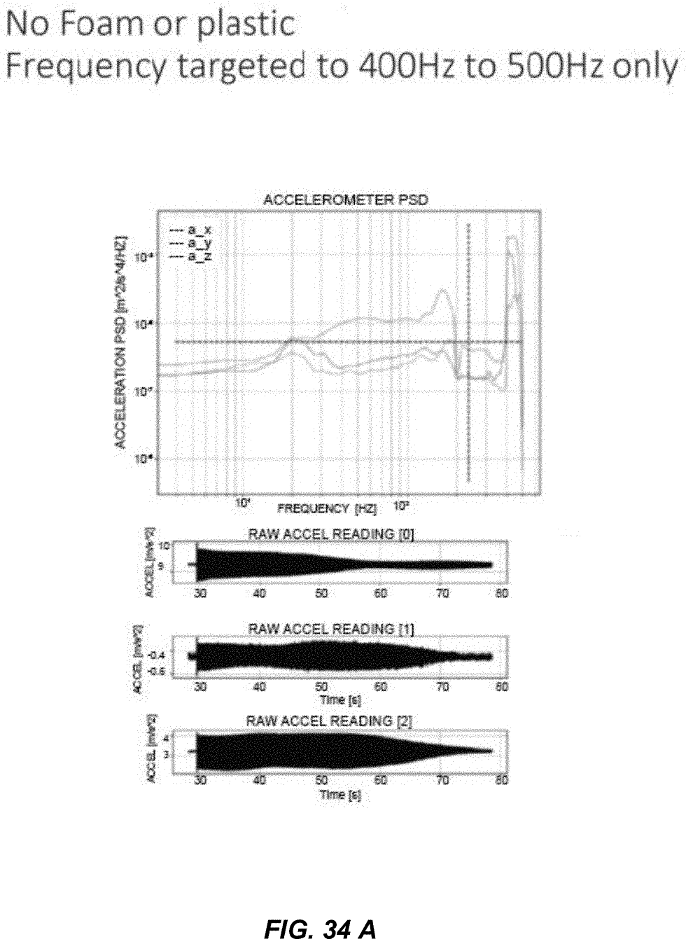

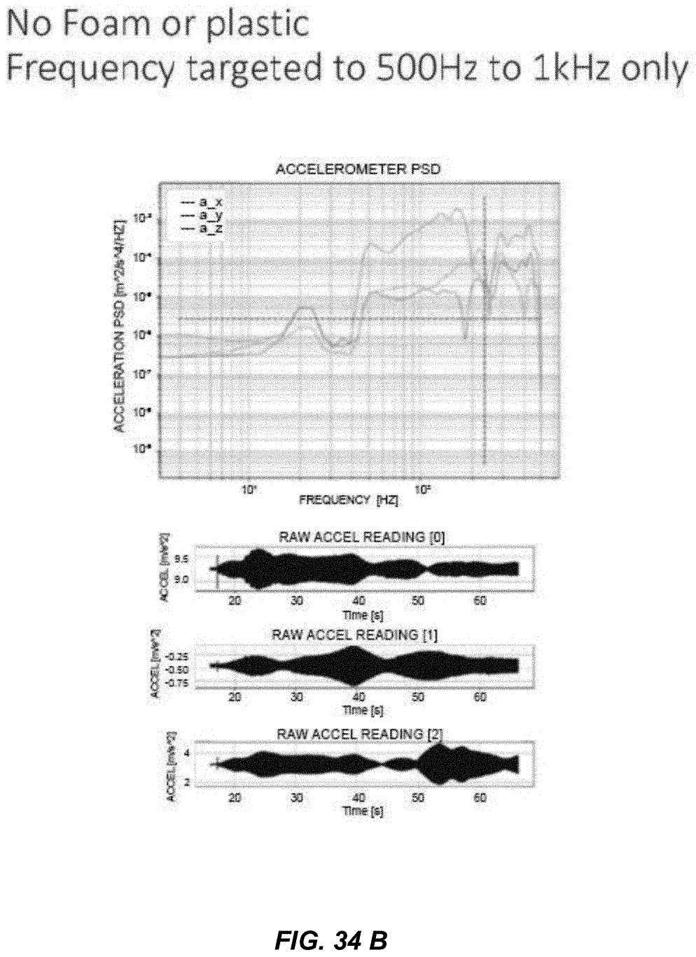

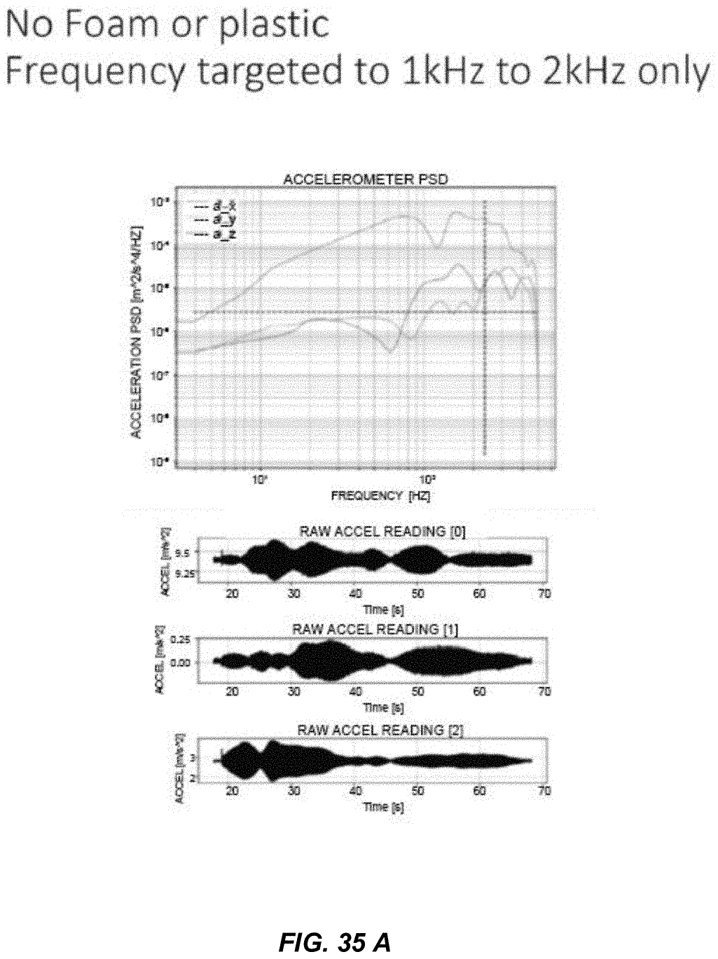

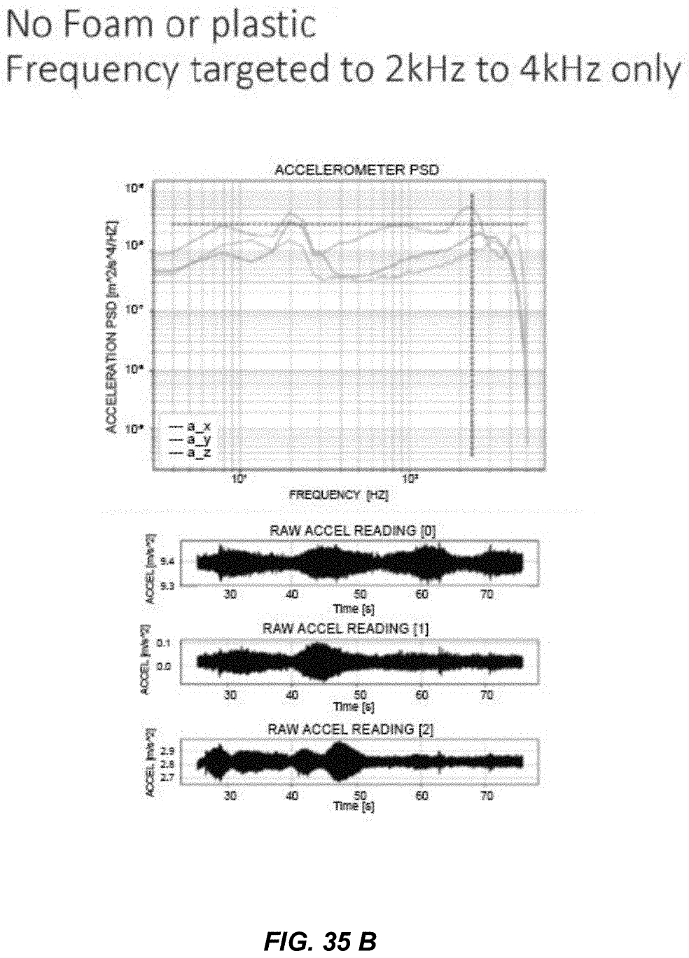

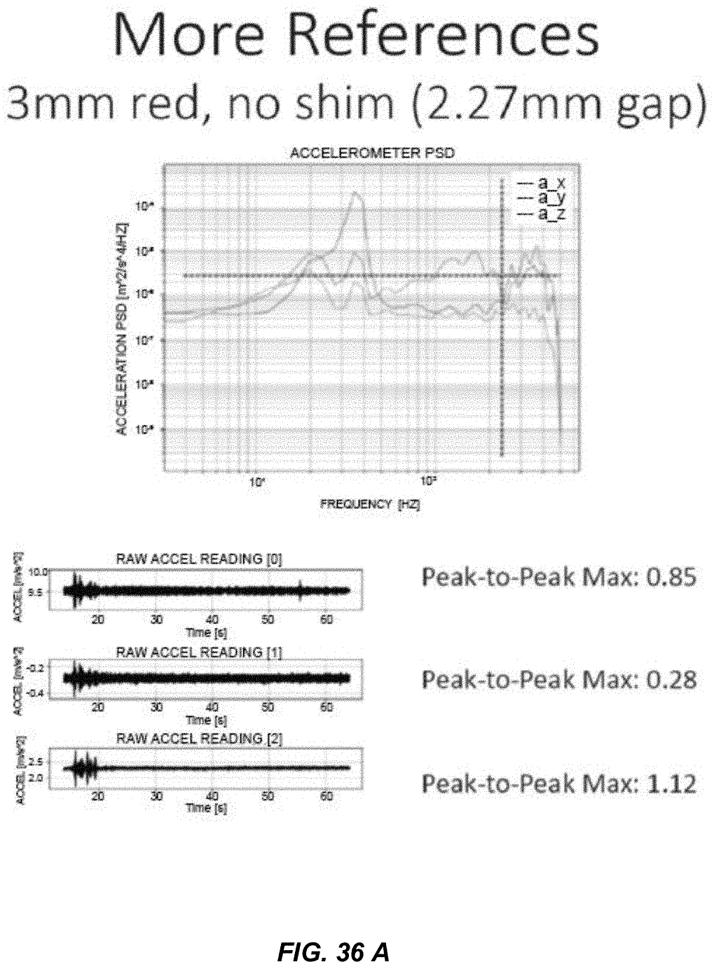

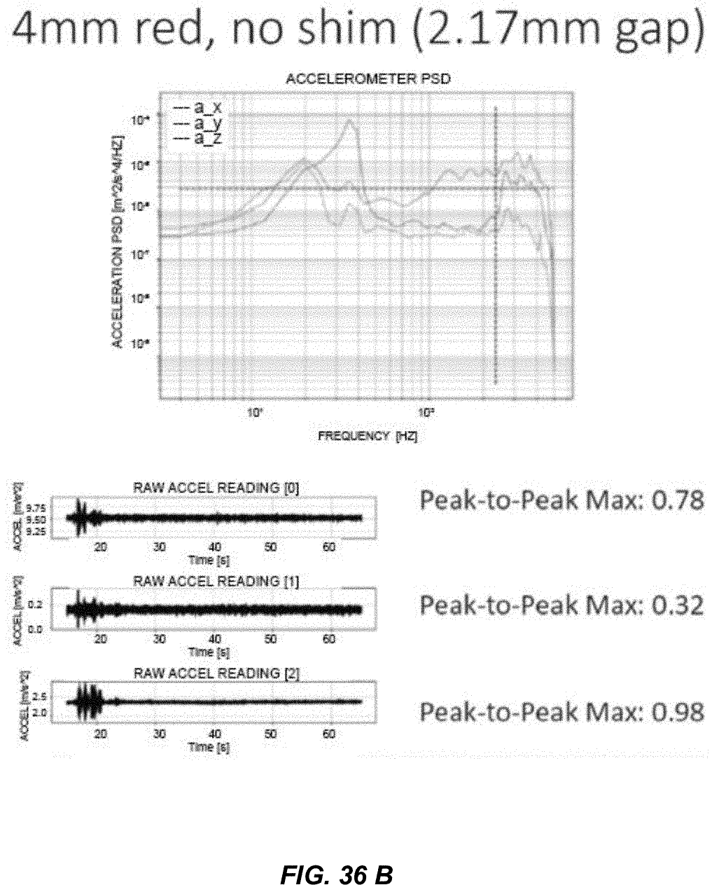

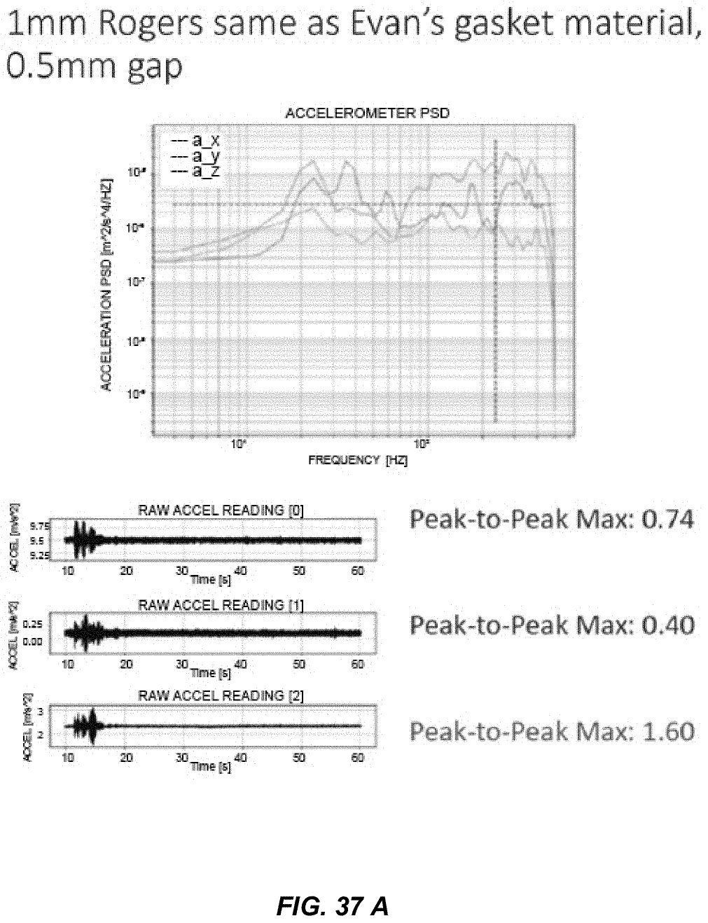

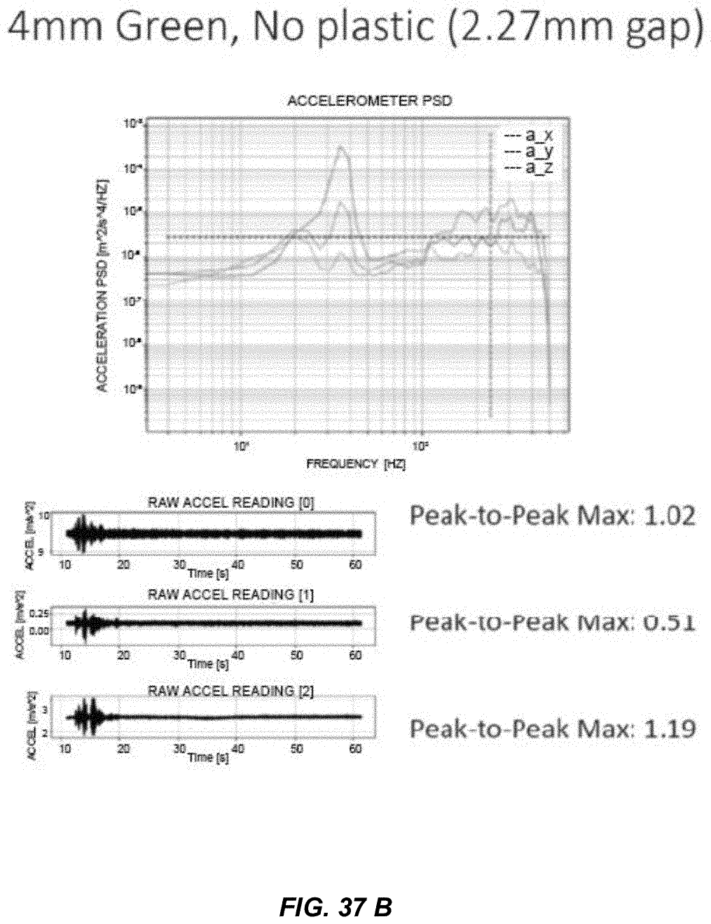

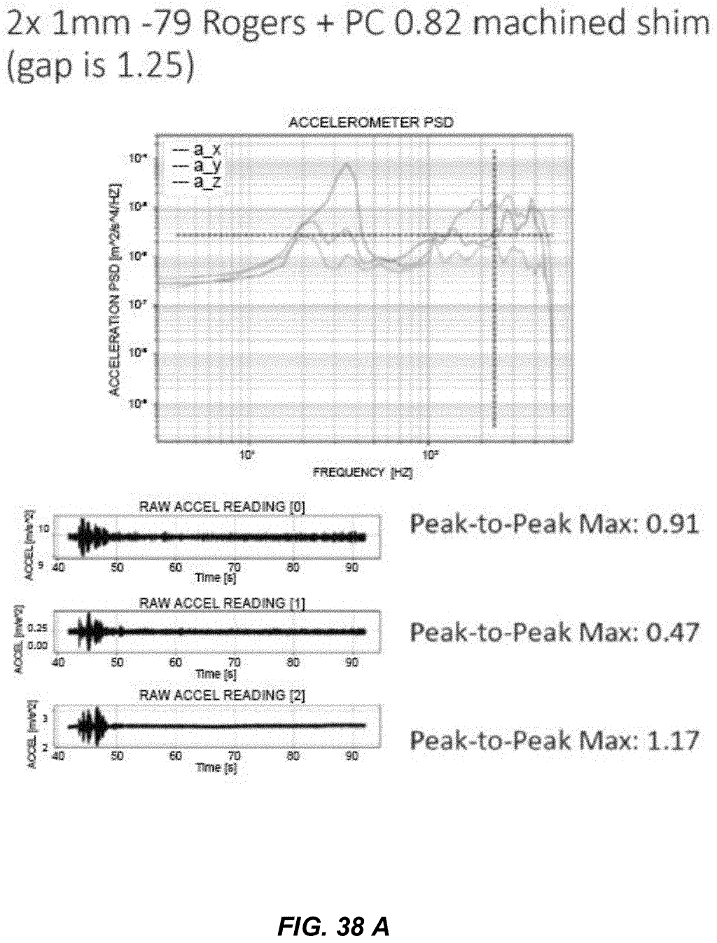

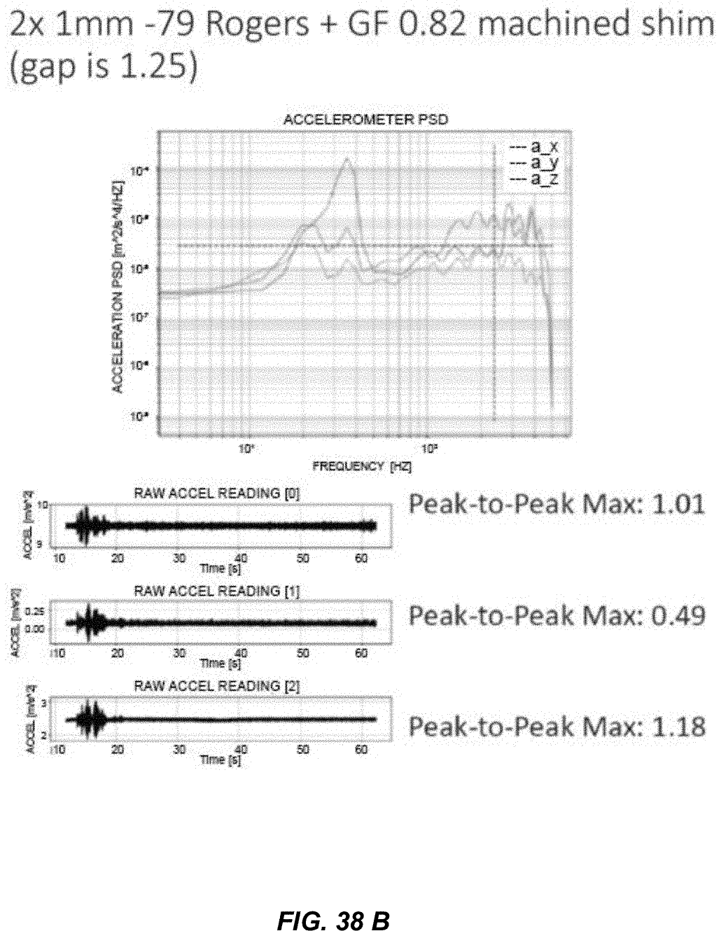

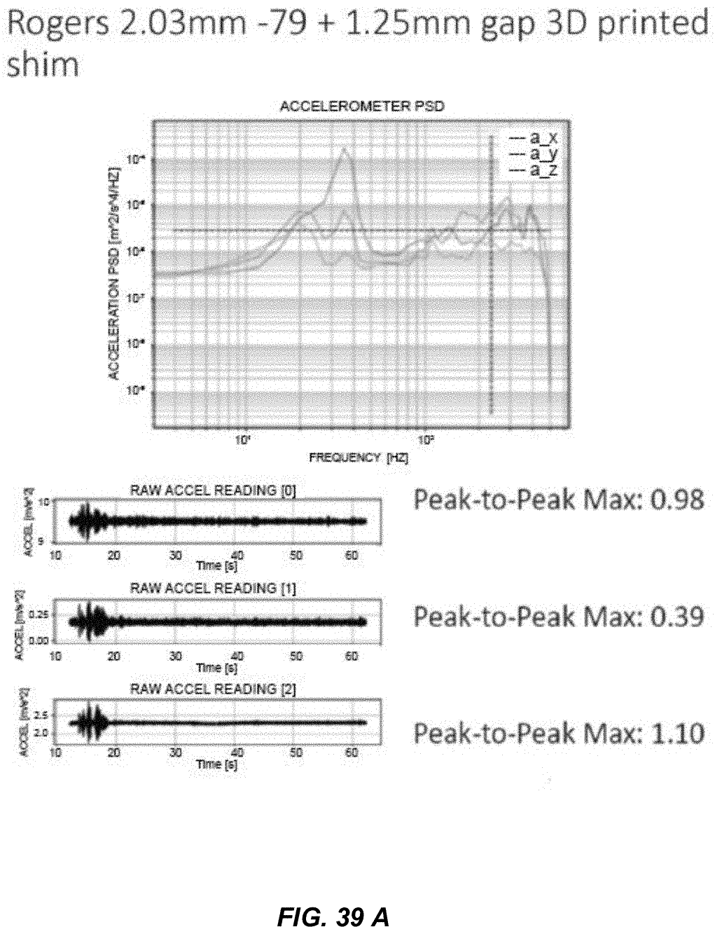

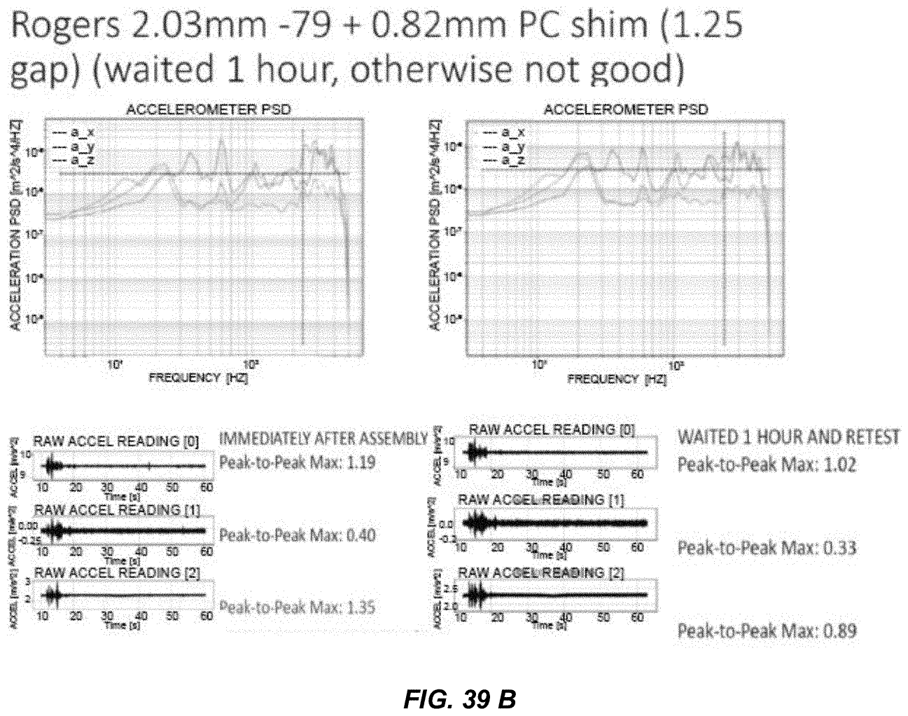

FIG. 6 depicts a table 600 having several examples of materials and configurations of the isolation assembly. Table 600 includes columns for foam type, foam thickness, a gap (which may be at least partially occupied by the compressed foam), the compression percentage, whether the rigid piece 312 (referred to as a “shim”) has a sidewall, and the corresponding drawing in FIGS. 27-39B showing sample testing results of the particular configuration.

### Example Embodiments

### Example 1

A system may include a circuit board, an inertial measurement unit (“IMU”) coupled to the circuit board, a frame, and an isolation assembly disposed between the circuit board and the frame, with the isolation assembly configured to reduce vibrations in least a portion of the circuit board adjacent to the IMU.

### Example 2

the system of Example 1, where the isolation assembly may include one or more of a rigid piece or a compressible foam layer.

### Example Shock-Absorbing Devices and Related Systems and Methods

A traditional electronic device (e.g., an image sensor) may include components configured to protect the electronic device from ingression of foreign substances such as dust, water, etc. For example, a traditional image sensor may include seals, coatings, housings, mountings, etc., that are configured and positioned to protect the image sensor and ensure its reliability. However, these traditional image sensor components may be deficient in preventing damage to the image sensor from forces associated with a shock impact. Systems, devices, and methods of the present disclosure may overcome these deficiencies. For example, embodiments of the present disclosure may include a shock-absorbing device that is configured to surround an image sensor and absorb a shock impact. The absorption of the impact force by the shock-absorbing device may substantially maintain a structural integrity of the image sensor when the image sensor is subjected to the impact.

Artificial-reality system often include a head-mounted display (HMD) that can be worn by a user while playing a video game or carrying out some other artificial-reality activity. Due to the active nature of many artificial-reality games or activities, the user may accidentally drop the HMD. The user may also accidentally drop the HMD while holding the HMD, putting the HMD on, or taking the HMD off. In some embodiments, an artificial-reality system may include an image sensor mounted on and protruding from a surface of the HMD. Given the possibility that the HMD may be dropped, the instant disclosure identifies and addresses a need for mounting and configuring the image sensors on the HMD in such a way as to prevent the image sensors from experiencing impact damage when the HMD is dropped. In some examples, these image sensors may include a compressible shock-absorbing device mounted on the image sensor to prevent damage to the image sensor when the HMD is dropped.

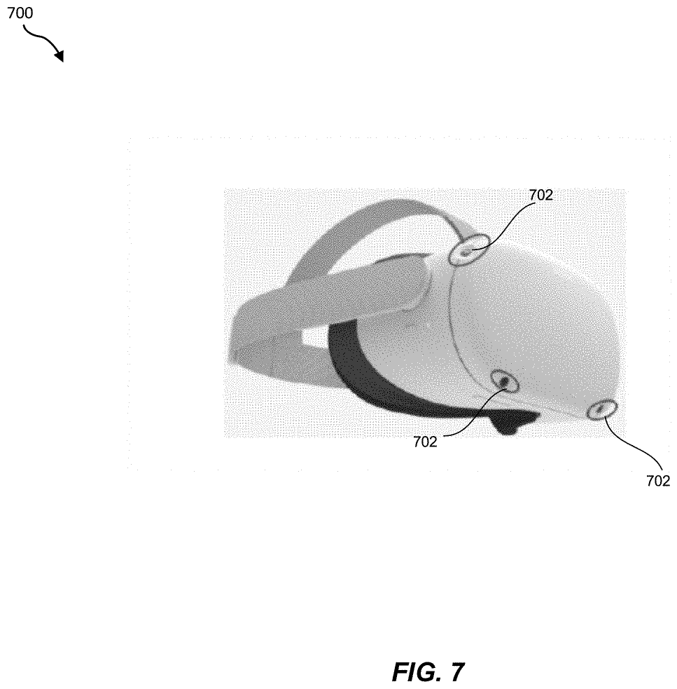

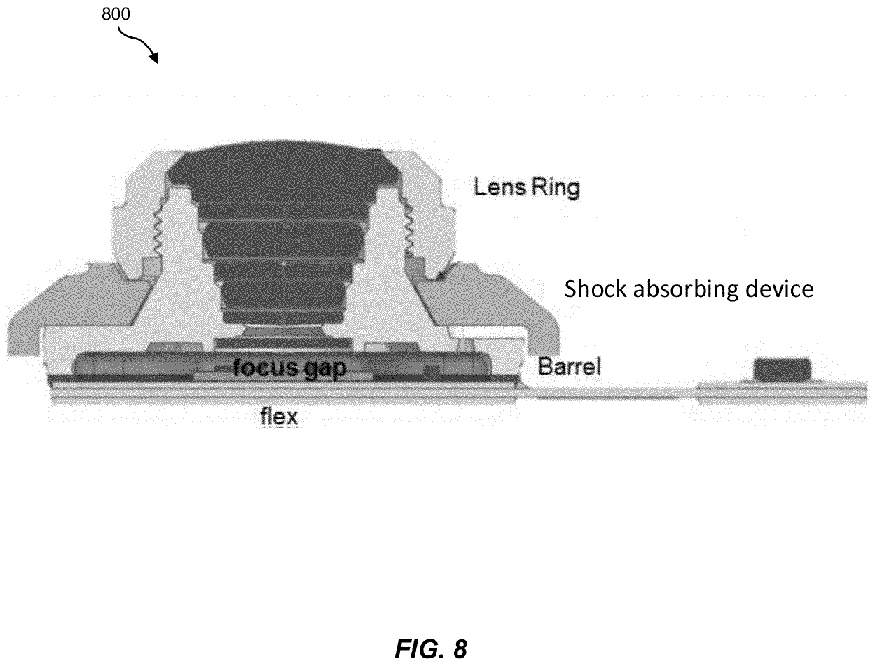

The following will provide, with reference to FIGS. 7-11, detailed descriptions of systems and devices for protecting electronic devices, such as image sensors by disposing a shock-absorbing device substantially around a portion of the image sensor.

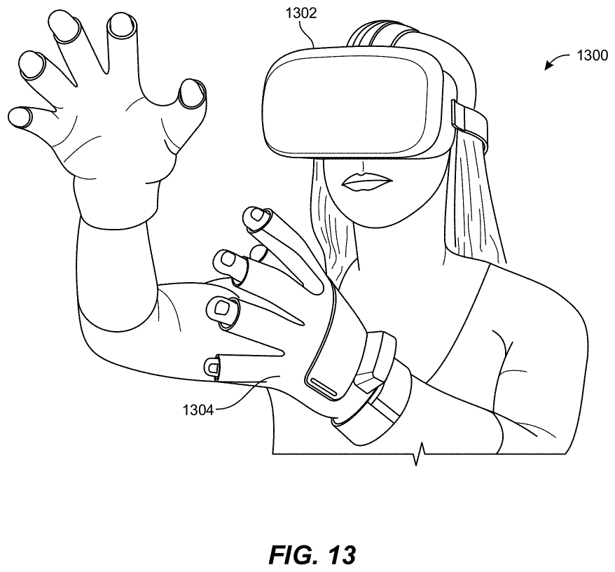

FIG. 7 illustrates an example HMD 700 including image sensors 702 mounted to (e.g., extending from) HMD 700, according to at least one embodiment of the present disclosure. In some embodiments, image sensors 702 are mounted on and protruding from a surface (e.g., a front surface, a corner surface, etc.) of HMD 700. HMD 700 may include virtual-reality system 1300 of FIG. 13 or HMD 102 of FIG. 1. Image sensors 702 may include sensor 140 of FIG. 1. A compressible shock-absorbing device may be mounted on image sensors 702. As will be described with reference to FIGS. 8, 9, and 11 below, the shock-absorbing device may be configured to substantially maintain the structural integrity of image sensors 702 in case an impact force is imparted on image sensors 702. In some embodiments, image sensors 702 may protrude from a surface (e.g., the front surface) of HMD 700 so as to increase a field of view of image sensors 702. In some examples, image sensors 702 may be pivotally and/or translationally mounted to HMD 700 to pivot image sensors 702 at a range of angles and/or to allow for translation in multiple directions in response to an impact. For example, image sensors 702 may protrude from the front surface of HMD 700 so as to give image sensors 702 a 180-degree field of view of objects (e.g., a surrounding real-world environment).

FIG. 8 is a cross-sectional view of an image sensor 800, according to at least one embodiment of the present disclosure. Image sensor 800 may include a lens, a lens ring, a shock-absorbing device, a barrel, and a flexible connector. When image sensor 800 experiences a shock impact, the shock-absorbing device may absorb, distribute, transfer, dampen, and/or reduce the shock impact force such that the components of image sensor 800 remain structurally and functionally intact. The shock-absorbing device may prevent the transfer of impact energy between the components of image sensor 800 by absorbing and/or dampening the impact energy. The shock-absorbing device may dampen the impact energy by the dispersion or disruption of the energy caused by shock's impact forces. The shock-absorbing device may absorb the energy from the shock by decreasing the amplitude (strength) of the shock energy's wave or by changing the shock wave's frequency. The absorption of impact energy may reduce or eliminate adverse effects or damage to the components (e.g., the barrel) of image sensor 800 caused by shock, thereby retaining the structural integrity of image sensor 800.

Image sensor 800 may include image sensor 702 of FIG. 7 that is integrated into HMD 700. In some embodiments, image sensor 800 may include a shock-absorbing device comprising a resilient material that is configured to compress inwards towards the lens ring of image sensor 800 when image sensor 800 experiences a shock force, such as resulting from dropping of the HMD. The resilient material may be configured to return to its original shape once the force is removed so as to return image sensor 800 to a position protruding forward from the front surface of the HMD. This configuration may improve durability of the coupling of image sensor 800 to the HMD so as to reduce the possibility of image sensor 800 being damaged or separated from the HMD upon force of impact.

In some examples, the shock-absorbing device of image sensor 800 may include a shock-absorbing material with a structure capable of distributing an applied stress (e.g., stress resulting from a shock force acting on image sensor 800 when the HMD is dropped). In some embodiments, the shock-absorbing material may include a material capable of converting the kinetic energy of the shock into another form of energy, for example heat energy, which is then dissipated. The shock-absorbing device may transfer the impact energy to another component of image sensor 800 and/or to another component of the HMD. For example, the shock-absorbing device may transfer the impact energy to a base of image sensor 800.

The shock-absorbing material may include, without limitation, a polymer material, an elastomer, a plastic, a polyethylene material, a polycarbonate material, an acrylonitrile butadiene styrene (ABS) material, a visco-elastic polymer material, a polymer matrix composite material, a fiber-reinforced polymer composite material, a polyurethane material, a butyl rubber material, a neoprene rubber material, or a combination thereof. This configuration has the advantage that the shock-absorbing material will compress upon receiving the initial shock and then return to its original shape and configuration when the stress is removed. This flexibility allows the shock-absorbing device to reversibly compress and/or extend. In some examples, the shock-absorbing material may have a compressive modulus in the range of 1-2, 2-3, 3-4, 4-5, 5-6, 6-7, or 7-8.

In some examples, image sensor 800 may include a flexible connector and/or flexible cable for data communications with a processor of the HMD. In the event of dropping of the HMD, the flat flexible connector and/or flexible cable may be configured to flex accordingly to prevent a disconnection of the electrical connection between the image sensor 800 and the HMD.

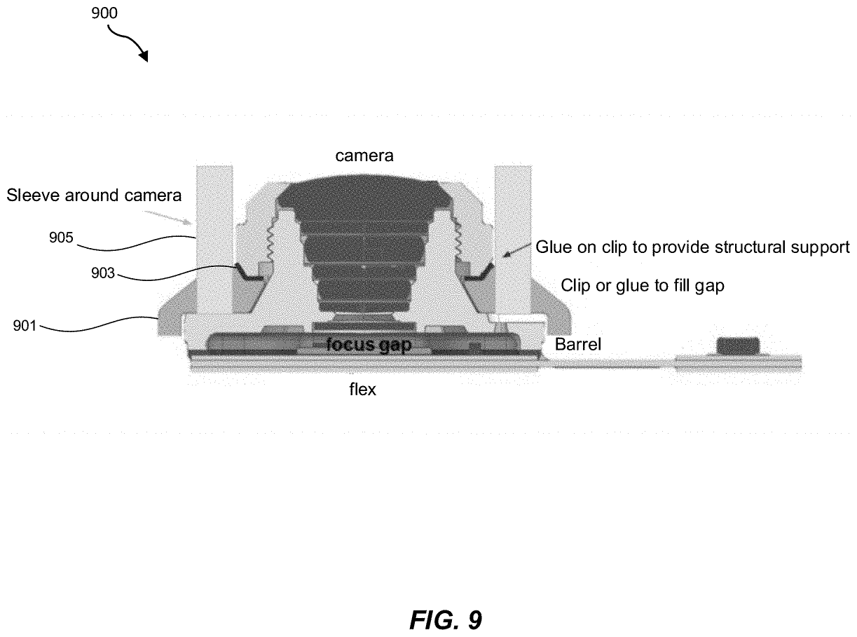

FIG. 9 is a cross-sectional view of an image sensor 900, according to at least one embodiment of the present disclosure. Image sensor 900 may include a lens, a lens ring, a shock-absorbing device 901, a barrel, an adhesive 903, a sleeve 905, and a flexible connector. When image sensor 900 experiences a shock impact, shock-absorbing device 901 may absorb, distribute, transfer, dampen, and/or reduce the shock impact force such that the components of image sensor 900 remain structurally and functionally intact. Shock-absorbing device 901 may prevent the transfer of impact energy between the components of image sensor 900 by absorbing and/or dampening the impact energy. Shock-absorbing device 901 may dampen the impact energy by the dispersion or disruption of the energy caused by shock's impact forces. Shock-absorbing device 901 may absorb the energy from the shock by decreasing the amplitude (strength) of the shock energy's wave or by changing the shock wave's frequency. The absorption of impact energy may reduce or eliminate adverse effects or damage to the components of image sensor 900 caused by shock, thereby retaining the structural integrity of image sensor 900.

Image sensor 900 may include image sensor 702 of FIG. 7 that is integrated into HMD 700. In some embodiments, image sensor 900 may include shock-absorbing device 901 that includes a resilient material configured to compress (e.g., compress inwards towards the lens ring of image sensor 900) when image sensor 900 experiences a shock impact resulting from dropping of the HMD. The resilient material may be configured to return to its original shape once the impact force is removed so as to return image sensor 900 to a position protruding forward from the front surface of the HMD. This configuration may improve durability of the coupling of image sensor 900 to the HMD to reduce the possibility of image sensor 900 being damaged or separated from the HMD upon force of impact.

In some examples, shock-absorbing device 901 of image sensor 900 may include a shock-absorbing material with a structure capable of distributing an applied stress (e.g., stress resulting from a shock or impact force acting on image sensor 900 when the HMD is dropped). In some embodiments, the shock-absorbing material may include a material capable of converting the kinetic energy of the shock into another form of energy, for example heat energy, which is then dissipated. Shock-absorbing device 901 may transfer the impact energy to another component of image sensor 900 and/or to another component of the HMD. For example, shock-absorbing device 901 may transfer the impact energy to a base of image sensor 900. Image sensor 900 may include sleeve 905. Sleeve 905 may be positioned around the entire perimeter of image sensor 900, positioned around a portion of the perimeter of image sensor 900, or positioned in proximity to image sensor 900. Sleeve 905 may include any type of rigid material including, without limitation, metal, ABS plastic, ceramics, carbides, or a combination thereof. In some examples, shock-absorbing device 901 may transfer the impact energy to sleeve 905 of image sensor 900. Additionally or alternatively, sleeve 905 may absorb, distribute, transfer, dampen, and/or reduce the shock impact force such that the components of image sensor 900 remain structurally and functionally intact. In some examples, shock-absorbing device 901 may be assembled on image sensor 900 after image sensor 900 is installed in an HMD (e.g., HMD 700 of FIG. 7). For example, shock-absorbing device 901 may be installed on image sensor 900 by expanding a radius of shock-absorbing device 901 and fitting shock-absorbing device 901 around a portion (e.g., the barrel) of image sensor 900. In some examples, shock-absorbing device 901 may be adhered to image sensor 900 using an adhesive 903 disposed between shock-absorbing device 901 and image sensor 900. In some examples, the combination of sleeve 905, shock-absorbing device 901, and adhesive 903 may provide structural support to image sensor 900.

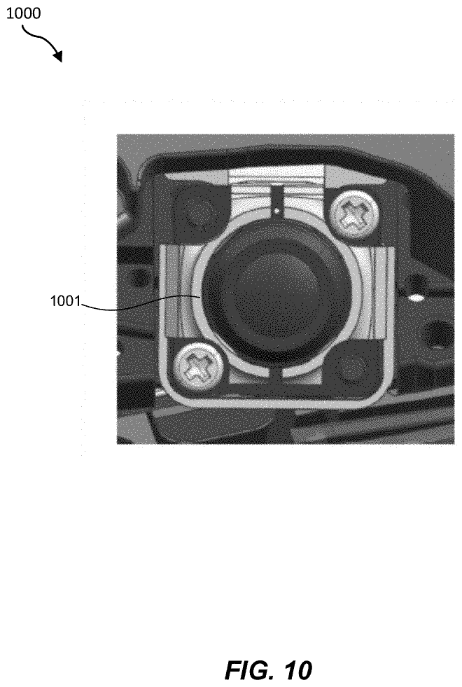

FIG. 10 is a plan view of an image sensor 1000, according to at least one embodiment of the present disclosure. Image sensor 1000 may include shock-absorbing device 1001. Shock-absorbing device 1001 may be positioned to substantially surround a portion (e.g., the barrel) of image sensor 1000. In some examples, when image sensor 1000 experiences a shock impact, shock-absorbing device 1001 may absorb, distribute, transfer, dampen, and/or reduce the shock impact force such that the components of image sensor 1000 remain structurally and functionally intact. Shock-absorbing device 1001 may prevent the transfer of impact energy between the components of image sensor 1000 by absorbing and/or dampening the impact energy. Shock-absorbing device 1001 may dampen the impact energy by the dispersion or disruption of the energy caused by shock's impact forces. Shock-absorbing device 1001 may absorb the energy from the shock by decreasing the amplitude (strength) of the shock energy's wave or by changing the shock wave's frequency. The absorption of impact energy may reduce or eliminate adverse effects or damage to the components of image sensor 1000 caused by shock, thereby retaining the structural integrity of image sensor 1000. In some examples, shock-absorbing device 1001 may be assembled on image sensor 1000 after image sensor 1000 is installed in an HMD (e.g., HMD 700 of FIG. 7). For example, shock-absorbing device 1001 may be installed on image sensor 1000 by expanding a radius of shock-absorbing device 1001 and fitting shock-absorbing device 1001 around a portion of image sensor 1000. In some examples, shock-absorbing device 1001 may include tabs and/or wings to assist in the assembly process of installing shock-absorbing device 1001 onto image sensor 1000. In some examples, shock-absorbing device 1001 may be adhered to image sensor 1000 using an adhesive disposed between shock-absorbing device 1001 and image sensor 1000.

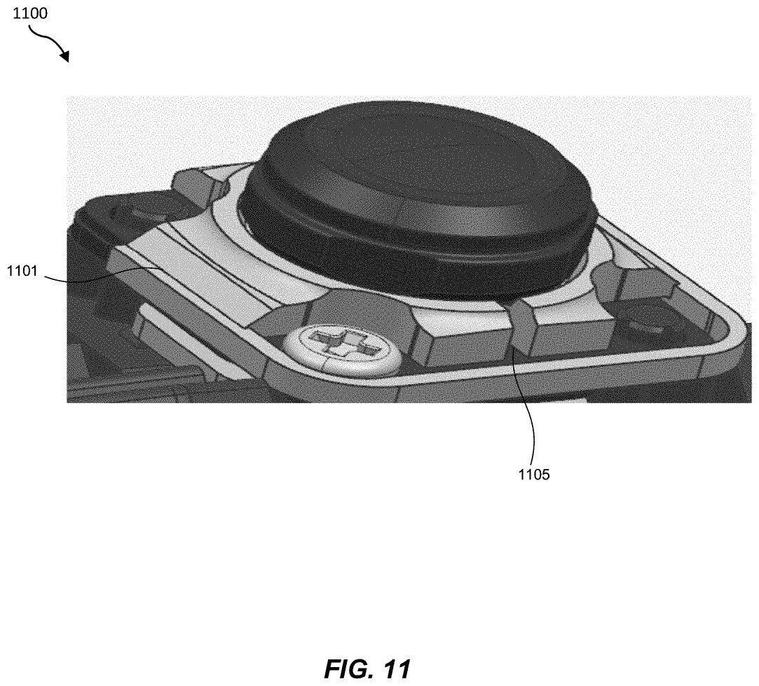

FIG. 11 is a perspective view of an image sensor 1100, according to at least one embodiment of the present disclosure. Image sensor 1100 may include shock-absorbing device 1101. Shock-absorbing device 1101 may be positioned to substantially surround a portion of image sensor 1100. For example, shock-absorbing device 1101 may be positioned to substantially surround a barrel portion of image sensor 1100. In some examples, when image sensor 1100 experiences a shock impact, shock-absorbing device 1101 may absorb, distribute, transfer, dampen, and/or reduce the shock impact force such that the components of image sensor 1100 remain structurally and functionally intact. Shock-absorbing device 1101 may prevent the transfer of impact energy between the components of image sensor 1100 by absorbing and/or dampening the impact energy. Shock-absorbing device 1101 may dampen the impact energy by the dispersion or disruption of the energy caused by shock's impact forces. Shock-absorbing device 1101 may absorb the energy from the shock by decreasing the amplitude (strength) of the shock energy's wave or by changing the shock wave's frequency. The absorption of impact energy may reduce or eliminate adverse effects or damage to the components of image sensor 1100 caused by shock, thereby retaining the structural integrity of image sensor 1100. In some examples, shock-absorbing device 1101 may be installed on image sensor 1100 after image sensor 1100 is installed in an HMD (e.g., HMD 700 of FIG. 7). For example, shock-absorbing device 1101 may be installed on image sensor 1100 by expanding a radius of shock-absorbing device 1101 and fitting shock-absorbing device 1101 around a portion of image sensor 1100. Shock-absorbing device 1101 may be configured as a “c-clip” that partially expands in opening 1105 in order to facilitate assembly of shock-absorbing device 1101 onto image sensor 1100. Shock-absorbing device 1101 may include tabs and/or wings positioned adjacent to opening 1105 to assist in the assembly process of installing shock-absorbing device 1101 onto image sensor 1100. In some examples, shock-absorbing device 1101 may be adhered to image sensor 1100 using an adhesive disposed between shock-absorbing device 1101 and image sensor 1100.

Embodiments of the present disclosure may include a system that includes a head-mounted display, an image sensor, and a shock-absorbing device. The shock-absorbing device may be shaped in the form of a ring (e.g., a C-clip) that includes a shock-absorbing material. The shock-absorbing device may be secured to the image sensor by an adhesive material. The shock-absorbing device may be shaped and configured to partially surround a portion of the image sensor. The image sensor may be integrated into the front portion of an HMD. When an impact force is imparted to the image sensor, the shock-absorbing device is configured to transfer the impact force to a base of the image sensor thereby maintaining the structural integrity of the image sensor preventing damage to the image sensor.

As noted, the artificial-reality systems 100 and 200 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

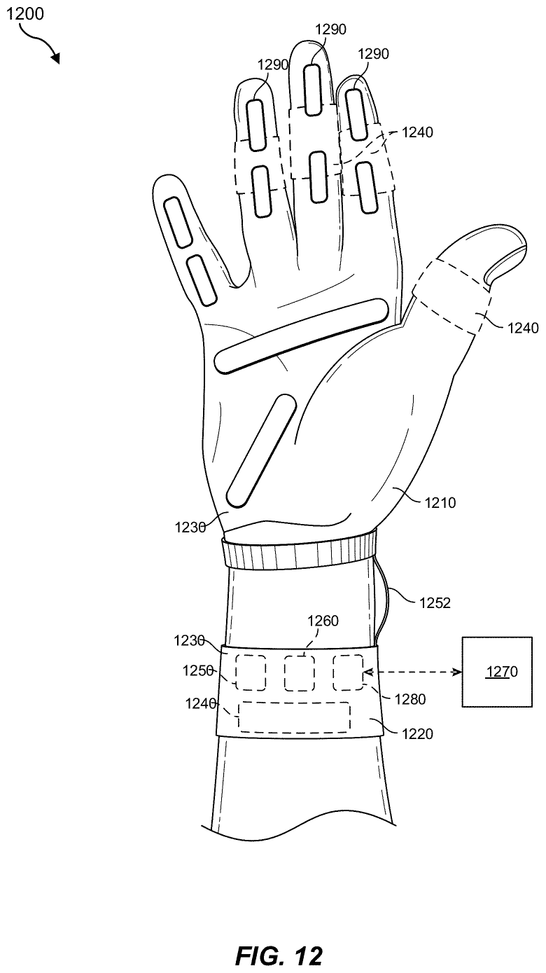

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 12 illustrates a vibrotactile system 1200 in the form of a wearable glove (haptic device 1210) and wristband (haptic device 1220). The haptic device 1210 and the haptic device 1220 are shown as examples of wearable devices that include a flexible, wearable textile material 1230 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, a composite material, etc.

One or more vibrotactile devices 1240 may be positioned at least partially within one or more corresponding pockets formed in the textile material 1230 of the vibrotactile system 1200. The vibrotactile devices 1240 may be positioned in locations to provide a vibrating sensation (e.g., haptic feedback) to a user of the vibrotactile system 1200. For example, the vibrotactile devices 1240 may be positioned to be against the user's finger(s), thumb, or wrist, as shown in FIG. 12. The vibrotactile devices 1240 may, in some examples, be sufficiently flexible to conform to or bend with the user's corresponding body part(s).

A power source 1250 (e.g., a battery) for applying a voltage to the vibrotactile devices 1240 for activation thereof may be electrically coupled to the vibrotactile devices 1240, such as via conductive wiring 1252. In some examples, each of the vibrotactile devices 1240 may be independently electrically coupled to the power source 1250 for individual activation. In some embodiments, a processor 1260 may be operatively coupled to the power source 1250 and configured (e.g., programmed) to control activation of the vibrotactile devices 1240.

The vibrotactile system 1200 may be implemented in a variety of ways. In some examples, the vibrotactile system 1200 may be a standalone system with integral subsystems and components for operation independent of other devices and systems. As another example, the vibrotactile system 1200 may be configured for interaction with another device or system 1270. For example, the vibrotactile system 1200 may, in some examples, include a communications interface 1280 for receiving and/or sending signals to the other device or system 1270. The other device or system 1270 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. The communications interface 1280 may enable communications between the vibrotactile system 1200 and the other device or system 1270 via a wireless (e.g., Wi-Fi, Bluetooth, cellular, radio, etc.) link or a wired link. If present, the communications interface 1280 may be in communication with the processor 1260, such as to provide a signal to the processor 1260 to activate or deactivate one or more of the vibrotactile devices 1240.

The vibrotactile system 1200 may optionally include other subsystems and components, such as touch-sensitive pads 1290, pressure sensors, motion sensors, position sensors, lighting elements, and/or user interface elements (e.g., an on/off button, a vibration control element, etc.). During use, the vibrotactile devices 1240 may be configured to be activated for a variety of different reasons, such as in response to the user's interaction with user interface elements, a signal from the motion or position sensors, a signal from the touch-sensitive pads 1290, a signal from the pressure sensors, a signal from the other device or system 1270, etc.

Although the power source 1250, the processor 1260, and the communications interface 1280 are illustrated in FIG. 12 as being positioned in the haptic device 1220, the present disclosure is not so limited. For example, one or more of the power source 1250, the processor 1260, or the communications interface 1280 may be positioned within the haptic device 1210 or within another wearable textile.

Haptic wearables, such as those shown in and described in connection with FIG. 12, may be implemented in a variety of types of artificial-reality systems and environments. FIG. 13 shows an example artificial-reality environment 1300 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 1302 generally represents any type or form of virtual-reality system, such as the virtual-reality system 200 in FIG. 2. Haptic device 1304 generally represents any type or form of wearable device, worn by a use of an artificial-reality system, that provides haptic feedback to the user to give the user the perception that he or she is physically engaging with a virtual object. In some embodiments, the haptic device 1304 may provide haptic feedback by applying vibration, motion, and/or force to the user. For example, the haptic device 1304 may limit or augment a user's movement. To give a specific example, the haptic device 1304 may limit a user's hand from moving forward so that the user has the perception that his or her hand has come in physical contact with a virtual wall. In this specific example, one or more actuators within the haptic advice may achieve the physical-movement restriction by pumping fluid into an inflatable bladder of the haptic device. In some examples, a user may also use the haptic device 1304 to send action requests to a console. Examples of action requests include, without limitation, requests to start an application and/or end the application and/or requests to perform a particular action within the application.

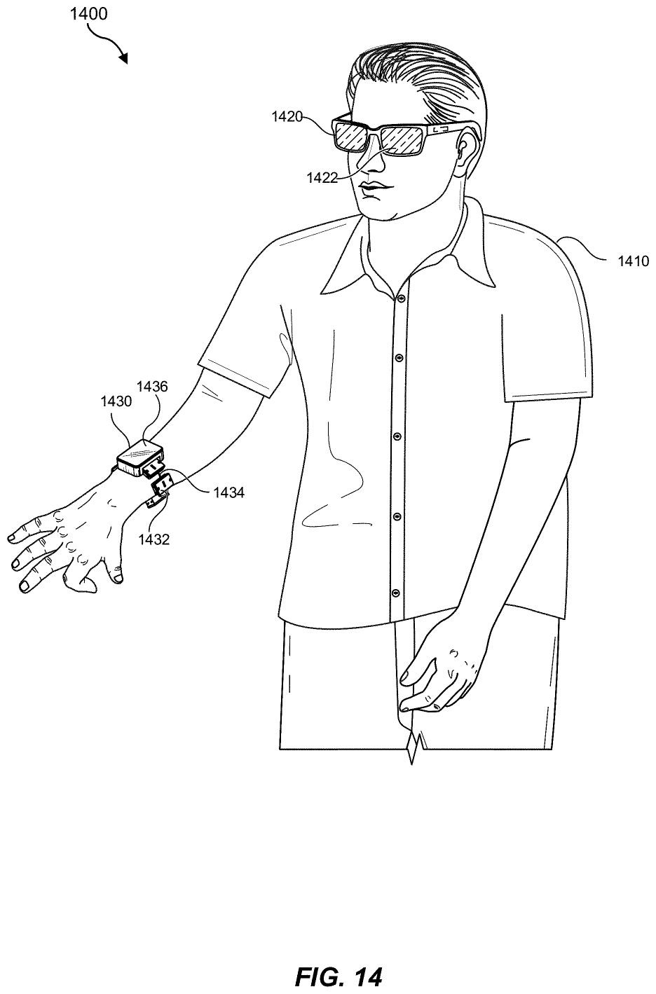

While haptic interfaces may be used with virtual-reality systems, as shown in FIG. 13, haptic interfaces may also be used with augmented-reality systems, as shown in FIG. 14. FIG. 14 is a perspective view a user 1410 interacting with an augmented-reality system 1400. In this example, the user 1410 may wear a pair of augmented-reality glasses 1420 that have one or more displays 1422 and that are paired with a haptic device 1430. The haptic device 1430 may be a wristband that includes a plurality of band elements 1432 and a tensioning mechanism 1434 that connects band elements 1432 to one another.

One or more of the band elements 1432 may include any type or form of actuator suitable for providing haptic feedback. For example, one or more of the band elements 1432 may be configured to provide one or more of various types of cutaneous feedback, including vibration, force, traction, texture, and/or temperature. To provide such feedback, the band elements 1432 may include one or more of various types of actuators. In one example, each of the band elements 1432 may include a vibrotactor (e.g., a vibrotactile actuator) configured to vibrate in unison or independently to provide one or more of various types of haptic sensations to a user. Alternatively, only a single band element or a subset of band elements may include vibrotactors.

The haptic devices 1210, 1220, 1304, and 1430 may include any suitable number and/or type of haptic transducer, sensor, and/or feedback mechanism. For example, the haptic devices 1210, 1220, 1304, and 1430 may include one or more mechanical transducers, piezoelectric transducers, and/or fluidic transducers. The haptic devices 1210, 1220, 1304, and 1430 may also include various combinations of different types and forms of transducers that work together or independently to enhance a user's artificial-reality experience. In one example, each of the band elements 1432 of the haptic device 1430 may include a vibrotactor (e.g., a vibrotactile actuator) configured to vibrate in unison or independently to provide one or more of various types of haptic sensations to a user.

By way of non-limiting examples, the following embodiments are included in the present disclosure.

### Example Embodiments

### Example 3

A shock-absorbing device, comprising a shock-absorbing material and an adhesive material, wherein the shock-absorbing material is shaped and configured to partially surround an image sensor and the adhesive material is positioned and configured to secure the shock-absorbing material to the image sensor.

### Example 4

The shock-absorbing device of Example 3, wherein when an impact force is imparted to the image sensor, the shock-absorbing material is configured to transfer the impact force to a base of the image sensor.

### Example 5

The shock-absorbing device of Example 3 or Example 4, wherein the shock-absorbing material is configured to absorb an impact force imparted to the image sensor.

### Example 6

The shock-absorbing device of any of Example 3 through 5, wherein absorbing the impact force imparted to the image sensor comprises distributing the impact force across the shock-absorbing material.

### Example 7

The shock-absorbing device of any of Examples 3 through 6, wherein the shock-absorbing material is configured to substantially maintain a structural integrity of the image sensor when an impact force is imparted to the image sensor.

### Example 8

The shock-absorbing device of any of Examples 3 through 7, wherein the shock-absorbing material comprises at least one of a polymer material, an elastomer, a plastic, a polyethylene material, a polycarbonate material, an acrylonitrile butadiene styrene material, a visco-elastic polymer material, a polymer matrix composite material, a fiber-reinforced polymer composite material, a polyurethane material, a butyl rubber material, or a neoprene rubber material.

### Example 9

The shock-absorbing device of any of Examples 3 through 8, wherein the image sensor is integrated into a head-mounted display.

### Example 10

A system comprising a head-mounted display, an image sensor, and a shock-absorbing device, wherein the shock-absorbing device comprises a shock-absorbing material, the shock-absorbing device is secured to the image sensor by an adhesive material, and the shock-absorbing material is shaped and configured to partially surround the image sensor.

### Example 11

The system of Example 10, wherein when an impact force is imparted to the image sensor, the shock-absorbing material is configured to transfer the impact force to a base of the image sensor.

### Example 12

The system of Example 10 or Example 11, wherein the shock-absorbing material is configured to absorb an impact force imparted to the image sensor.

### Example 13

The system of any of Examples 10 through 12, wherein absorbing the impact force imparted to the image sensor comprises distributing the impact force across the shock-absorbing material.

### Example 14

The system of any of Examples 10 through 13, wherein the shock-absorbing material is configured to substantially maintain a structural integrity of the image sensor when an impact force is imparted to the image sensor.

### Example 15

The system of any of Examples 10 through 14, wherein the shock-absorbing material comprises at least one of a polymer material, an elastomer, a plastic, or a polyethylene material.

### Example 16

The system of any of Examples 10 through 15, wherein the shock-absorbing material comprises at least one of a polycarbonate material, an acrylonitrile butadiene styrene material, a visco-elastic polymer material, a polymer matrix composite material, a fiber-reinforced polymer composite material, a polyurethane material, a butyl rubber material, or a neoprene rubber material.

### Example 17

The system of any of Examples 10 through 16, wherein the image sensor is integrated into a periphery of the head-mounted display.

### Example Embodiments for a Form-in-Place Gasket for Water Ingress Protection Around a Flexible Printed Circuit Board

Wearable electronic devices may be exposed to many solid and liquid components of the environment such as water and dust. These environmental components may cause the wearable electronic devices to malfunction and, in some cases, may even cause permanent damage. Wearable electronic devices, therefore, may benefit from a high level of water and dust ingress protection. As the size of wearable electronic devices becomes smaller, however, the wearable electronic devices may become too small and/or too complex in structure for the application of traditional water sealing design approaches for water and dust ingress protection. Other approaches for protecting these smaller more complex wearable electronic devices from these environmental components may involve implementing expensive, complicated, low-yield, and even government regulated processes.

The present disclosure is generally directed to using form-in-place gasket technology (which may also be referred to as cure-in-place gasket technology) to create an O-ring, gasket, or grommet that is formed around a flexible circuit. The form-in-place gasket technology used to create the integrated O-ring design may have negligible yield losses due to the use of room temperature processing. The integrated O-ring design may provide an effective water seal for water and/or dust ingress protection of the flexible circuit without the need for higher cost and/or lower yield process, and/or processes that may require the addition of glue, which may involve government restrictions.

The flexible circuit, which may also be referred to as a flex circuit, flexible electronics, a flexible printed circuit board (FPCB), a flex print, or a flex-circuit may include one or more circuit boards. The flexible circuit may bend or fold into any shape due to its small size and flexibility. The flexible circuit may dynamically flex allowing the use of three-dimensional space for placement and interconnection of electronics and circuits in wearable electronic devices. The integrated O-ring design may provide a high level of water and dust ingress protection around the flexible circuit by implementing a water and/or dust shield against single or multiple surfaces that enclose the flexible circuit. In particular, the integrated O-ring may be formed around one or more areas, portions, or sections of the flexible circuit that may dynamically flex or bend with use of the wearable electronic device.

As will be explained in greater detail below, embodiments of the present disclosure may use existing and easily available liquid dispense material and equipment to create a fitted gasket around a flexible circuit using form-in-place gasket technology. In some implementations, the system and methods described herein may form an O-ring, a gasket, or a grommet around an area, section, or portion of a flexible circuit that crosses a hinge or other bendable, flexible device included in a wearable electronic device. The O-ring, gasket, or grommet may provide a water and/or dust seal for that area, section, or portion of the flexible circuit that may dynamically bend or flex as the hinge is rotated.

Features from any of the embodiments described herein may be used in combination with one another in accordance with the general principles described herein. These and other embodiments, features, and advantages will be more fully understood upon reading the following detailed description in conjunction with the accompanying drawings and claims.

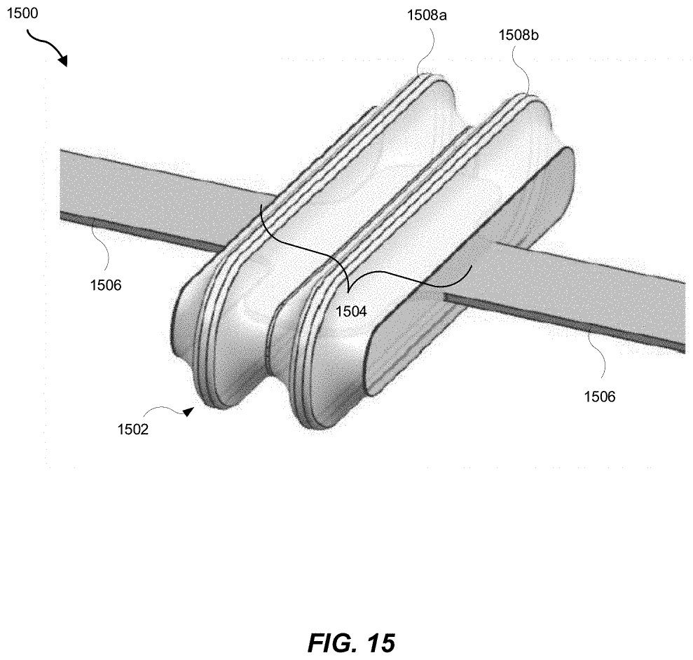

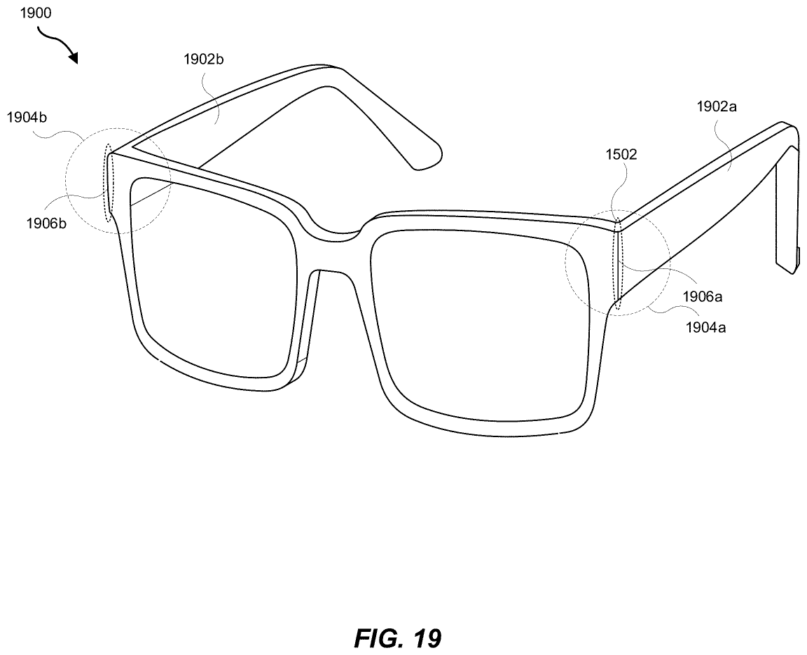

The following will provide, with reference to FIGS. 15 to 17, the formation of a gasket over a section of a flexible printed circuit board and, with reference to FIGS. 18 and 19, the placement of the flexible printed circuit board with the gasket in a wearable electronic device.

FIG. 15 is an illustration of an example top view 1500 of a gasket 1502 placed over a portion or section 1504 of a flexible printed circuit board 1506. The section 1504 of the flexible printed circuit board 1506 may be subject to repeated bending and flexing. The gasket 1502 may provide a water and/or dust seal for that section 1504 of the flexible printed circuit board 1506 that can withstand the repeated bending and flexing of the flexible printed circuit board 1506 in that section 1504.

A gasket may include one or more rows of compressible ribs. In a non-limiting example, the gasket 1502 may include one or more rows of compressible ribs (e.g., a first compressible rib row 1508a and a second compressible rib row 1508b). In some implementations, the gasket 1502 may include more than two (e.g., three or more) compressible rib rows. In some implementations, the gasket 1502 may include less than two (e.g., one) compressible rib rows.

A section of a flexible printed circuit board may be located or placed over a component that bends, flexes, or rotates. Forming a gasket around this section of the flexible printed circuit board may provide a water and/or dust seal for that section of the flexible printed circuit board that can withstand the repeated flexing of the flexible printed circuit board. In a non-limiting example, the section 1504 of the flexible printed circuit board 1506 may be located over a hinge or other type of bendable, flexible, or rotational device included in a wearable electronic device that bends, flexes, or rotates such that the section 1504 of the flexible printed circuit board 1506 may flex along with the device. For example, the section 1504 may be located on a hinge that couples an end piece of an eyeglass frame to a temple of the eyeglass frame. This will be described in more detail referring to the wearable electronic device 1900 as shown for example in FIG. 19.

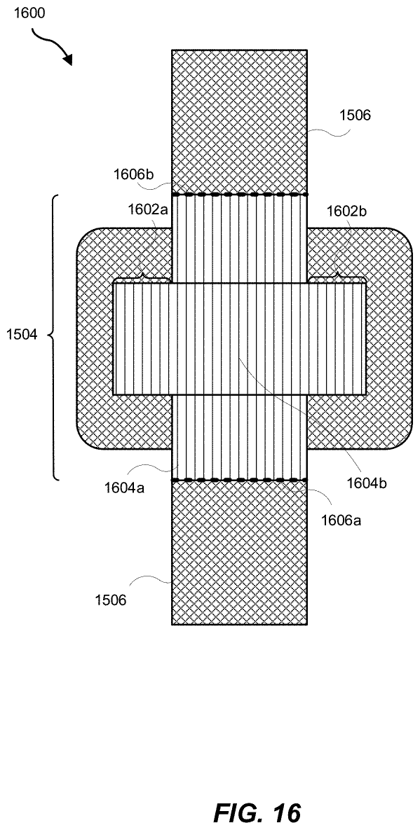

FIG. 16 is an illustration of an example top view 1600 of the flexible printed circuit board 1506 that shows wings 1602a-d included in the section 1504 of a flexible printed circuit board 1506 that is covered by or enclosed in the gasket 1502. In some implementations, additional materials may be deposited on portions 1604a-b of the flexible printed circuit board 1506. The additional materials may be deposited on both a top and bottom of the portions 1604a-b of the flexible printed circuit board 1506. For example, the additional materials may be deposited on an upper surface of the portions 1604a-b of the flexible printed circuit board 1506 and on a lower surface of the portions 1604a-b of the flexible printed circuit board 1506.

In some implementations, increased surface roughness and/or features may be included on the portions 1604a-b of the flexible printed circuit board 1506. The increased surface roughness and/or features may be included on both a top and bottom of the portions 1604a-b of the flexible printed circuit board 1506. For example, the increased surface roughness and/or features may be included on an upper surface of the portions 1604a-b of the flexible printed circuit board 1506 and on a lower surface of the portions 1604a-b of the flexible printed circuit board 1506.

Including the additional materials and/or the increased surface roughness and/or features on both the top and bottom of the portions 1604a-b of the flexible printed circuit board 1506 may increase the surface energy and/or roughness in the portions 1604a-b of the flexible printed circuit board 1506. The additional materials may improve the bond formed between the gasket 1502 that is placed over and around the section 1504 of the flexible printed circuit board 1506 and the flexible printed circuit board 1506. The increased surface roughness and/or the added features may result in a texture of the portions 1604a-b of the flexible printed circuit board 1506 allowing for an improved bond that may be formed between the gasket 1502 that is placed over and around the section 1504 of the flexible printed circuit board 1506 and the flexible printed circuit board 1506.

Wings included on a flexible printed circuit board may improve the interface between the flexible printed circuit board and a gasket. For example, the wings 1602a-d may improve the retention and/or alignment of the flexible printed circuit board 1506 within the gasket 1502. The improved retention and/or alignment may create a tortuous if not impossible path for the passing of water through the gasket 1502 and to the flexible printed circuit board 1506. The creating of such a path may provide the desired water ingress protection of the flexible printed circuit board 1506. In addition, or in the alternative, the improved retention and/or alignment may create a tortuous if not impossible path for the transmission of any dust to the flexible printed circuit board 1506, providing the desired dust ingress protection of the flexible printed circuit board 1506.

The combination of the wings and the additional materials and/or the increased surface roughness and/or the features included on the top and bottom portions 1604a-b of the flexible printed circuit board 1506 may improve the interface and/or bond between the flexible printed circuit board 1506 and the gasket 1502. The improved interface and/or bond may result in a high level of water and/or dust ingress protection of the flexible printed circuit board 1506, and in particular, may provide a high level of water and/or dust ingress protection in the section 1504 of the flexible printed circuit board 1506.

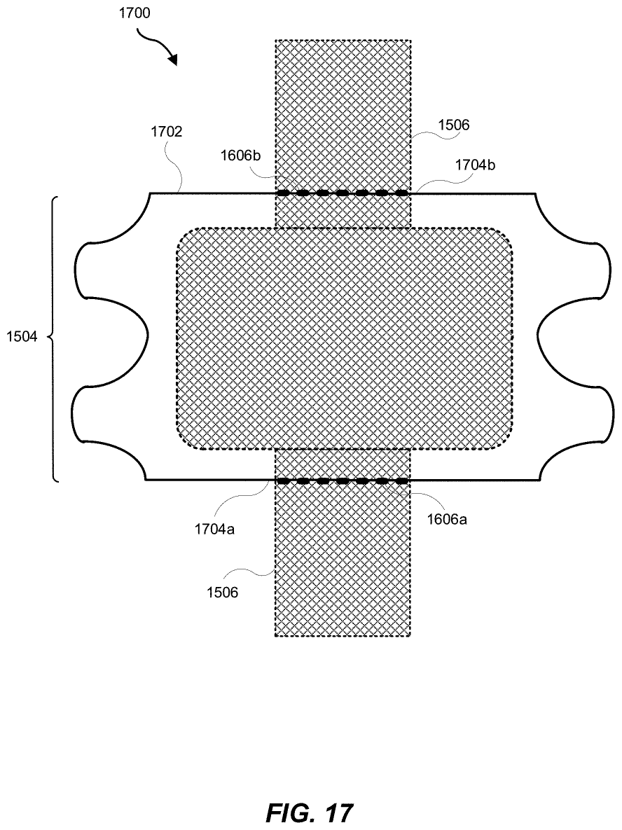

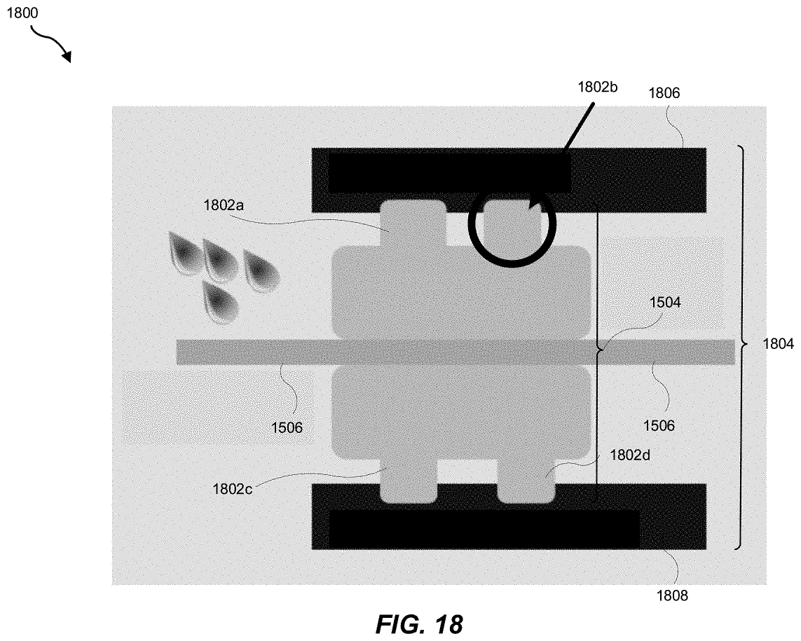

FIG. 17 is an illustration of an example top view 1700 of a molding fixture 1702 showing the section 1504 of the flexible printed circuit board 1506 placed inside of the molding fixture 1702. A section of a flexible printed circuit board may be placed in a molding fixture. The fixture may utilize form-in-place gasket technology to create an O-ring, gasket, or grommet around the section of the flexible printed circuit board included in the molding fixture. Referring to FIGS. 15, 16, and 17, the section 1504 of the flexible printed circuit board 1506 may be placed in the molding fixture 1702. The molding fixture 1702 may be a mold designed for use with form-in-place gasket technology. The use of form-in-place gasket technology with the molding fixture 1702 while the section 1504 of the flexible printed circuit board 1506 is located inside of the molding fixture 1702 may produce the gasket 1502. For example, the molding fixture 1702 may be of a shape and size to produce the gasket 1502.

One or more alignment marks included on a flexible printed circuit board may aid in the placement or installation of the flexible printed circuit board in a molding fixture. In a non-limiting example, alignment marks 1606a-b may aid in the placement of the section 1504 of the flexible printed circuit board 1506 into the molding fixture 1702. In some implementations, the alignment marks 1606a-b may be markings added to the flexible printed circuit board 1506 at locations on the flexible printed circuit board 1506 for aligning with respective edges 1704a-b of the molding fixture 1702. In some implementations, more than two alignment marks (e.g., three or more alignment marks) may be included on the flexible printed circuit board to aid in the placement of the flexible printed circuit board in the molding fixture. In some implementations, less than two alignment marks (e.g., one alignment mark) may be included on the flexible printed circuit board to aid in the placement of the flexible printed circuit board in the molding fixture.

In some implementations, one or more features included on a flexible printed circuit board may aid in the placement or installation of the flexible printed circuit board in a molding fixture. For example, a feature may be an indent, detent, nub, or symbol on the flexible printed circuit board for alignment with a feature included on the molding fixture. Alignment of the features of the flexible printed circuit board and the molding fixture may assure proper placement of the section of the flexible printed circuit board in the molding fixture 1702 such that the alignment marks 1606a-b align with the respective edges 1704a-b of the molding fixture 1702.

Once a section of a flexible printed circuit board is placed or installed in a molding fixture, a thick liquid may be dispensed into the molding fixture for placement around the section of the flexible printed circuit board in the molding fixture. The placement of the thick liquid into the molding fixture may be part of the form-in-place gasket technology used to create the gasket that then surrounds and encompasses the section of the flexible printed circuit board providing water and/or dust ingress protection. Referring to FIGS. 15, 16, and 17, the section 1504 of the flexible printed circuit board 1506 may be placed or installed into the molding fixture 1702. The gasket 1502 may be formed over and surrounding the section 1504 of the flexible printed circuit board 1506 by dispensing a thick liquid into the molding fixture 1702 and allowing the thick liquid to fully cure.

The thick liquid may be dispensed at ambient or room temperature or at a slightly elevated ambient temperature to avoid damaging the flexible printed circuit board 1506. For example, the thick liquid may be a fluid elastomer such as silicon rubber. The temperature of the thick liquid may be at substantially ambient or room temperature. For example, the dispensing of the thick liquid may occur at a temperature in the range of approximately 60 to 80 degrees Fahrenheit. In addition, the dispensing of a thick liquid into the molding fixture 1702 may provide substantially 100 percent coverage (99 percent or more coverage) of the section 1504 of the flexible printed circuit board 1506. This full coverage of the section 1504 of the flexible printed circuit board 1506 may provide a seal that surrounds the section 1504 of the flexible printed circuit board 1506 that keeps out water and/or dust while still allowing the section 1504 of the flexible printed circuit board 1506 to bend and flex. The thick liquid may cure in the molding fixture 1702 at substantially ambient or room temperature (e.g., at a temperature in the range of approximately 60 to 80 degrees Fahrenheit). In some implementations, the temperature of the thick liquid and the curing temperature may be substantially the same (e.g., within ±10 percent). In some implementations, the temperature of the thick liquid and the curing temperature may be different.

Once cured, the flexible printed circuit board may be removed from the molding fixture. In a non-limiting example, once the curing process is complete, the flexible printed circuit board 1506 may be removed from the molding fixture 1702 and placed into a wearable electronic device.

FIG. 18 is an illustration of an example cross-sectional side view 1800 of the section 1504 of the flexible printed circuit board 1506 as incorporated into an enclosure 1804 of a device (e.g., a wearable electronic device) that includes a top 1806 and a bottom 1808. The gasket 1502 may be placed over the section 1504 of the flexible printed circuit board 1506. The flexible printed circuit board 1506 may be located between the top 1806 of the enclosure 1804 and the bottom 1808 of the enclosure 1804.

One or more compressible ribs included in a gasket that is part of and encloses a section of a flexible printed circuit board may create a water and/or dust seal against a top or upper part of an enclosure and a bottom or lower part of an enclosure that includes the flexible printed circuit board. In addition, or in the alternative, the one or more compressible ribs may prevent rotation of the gasket in the enclosure, thereby preventing the rotation of the section of the flexible printed circuit board protected by the gasket. In a non-limiting example, referring to FIG. 15, the gasket 1502 may include the first compressible rib row 1508a and the second compressible rib row 1508b, both of which surround the section 1504 of the flexible printed circuit board 1506. As illustrated in FIG. 18, the example cross-sectional side view 1800 shows a top 1802a of the first compressible rib row 1508a providing a seal against the top 1806 of the enclosure 1804 and a bottom 1802c of the first compressible rib row 1508a providing a seal against the bottom 1808 of the enclosure 1804. The example cross-sectional side view 1800 also shows a top 1802b of the second compressible rib row 1508b providing a seal against the top 1806 of the enclosure 1804 and a bottom 1802d of the second compressible rib row 1508b providing a seal against the bottom 1808 of the enclosure 1804. Though two rows of compressible ribs are shown, in some implementations the gasket 1502 may include more than two (e.g., three or more) compressible rib rows, and in other implementations the gasket 1502 may include less than two (e.g., one) compressible rib rows.

FIG. 19 is an illustration of an example wearable electronic device 1900. The wearable electronic device 1900 may be eyeglasses or any other type of glasses worn over the eyes of a user. The wearable electronic device 1900 may include temples 1902a-b, end pieces 1904a-b, and hinges 1906a-b, respectively. The hinges 1906a-b may be included in or be part of the end pieces 1904a-b, respectively.

A flexible printed circuit board may be part of a wearable electronic device. One or both end pieces of the wearable electronic device may incorporate parts of the flexible printed circuit board. In a non-limiting example, the section 1504 of the flexible printed circuit board 1506 may be located in the end piece 1904a. The gasket 1502 may be placed over the hinge 1906a allowing the section 1504 of the flexible printed circuit board 1506 to flex with the rotation of the hinge 1906a. The gasket 1502 may provide water and/or dust ingress protection for the section 1504 of flexible printed circuit board 1506. Another section of the flexible printed circuit board that is enclosed in a gasket similar to the gasket 1502 may be incorporated into the end piece 1904b and placed over the hinge 1906b. For example, the wearable electronic device 1900 may be the eyewear device 102 of the exemplary augmented-reality system 100 shown in FIG. 1.

The use of form-in-place gasket technology to form an O-ring, gasket, or grommet around a section of a flexible printed circuit board may result in a gasket that provides a high level of water and/or dust ingress protection that uses an ambient temperature process without the need for higher cost and/or lower yield process and/or processes that may require the addition of glue, which may have government restrictions. In some cases, foams or pads may create a compressed seal between a flexible printed circuit board and an enclosure. Such seals, however, may leave a gap for water and/or dust ingress on the sides of the flexible printed circuit board. In contrast, referring for example to FIGS. 15 and 18, the first compressible rib row 1508a and the second compressible rib row 15 1508b of the gasket 1502 provide a seal against the top 1806 and the bottom 1808 of the enclosure 1804 that is impervious to water and/or dust.

In some cases, the use of an off-the-shelf O-ring would require the fitting of the O-ring over a larger and/or wider connector that may be located at the end of the flexible printed circuit board before it may be placed in the desired section of the flexible printed circuit board. To fit the O-ring over the connector, the O-ring may be stretched and therefore may not be sized appropriately when placed over the section of the flexible printed circuit board providing an inadequate sealing of the flexible printed circuit board in that section.

In some cases, glue may effectively seal any gaps in the compressed seal between a flexible printed circuit board and an enclosure. Glue, however, may be messy and may have specific heat, timing, and/or moisture requirements for proper curing that may involve the use of expensive specialized equipment. In addition, or in the alternative, the use of glue may involve compliance with environmental and/or government restrictions, further complicating the process. Also, the flow of any glue into the wearable electronic device should be prevented in order to protect not only the flexible printed circuit board but the wearable electronic device. Preventing the flow may result in a less than optimal geometry for the flexible printed circuit board that may result in providing a less than optimal seal between the flexible printed circuit board and an enclosure.

### Example Embodiments

### Example 18

A device may include a flexible printed circuit board including at least one section and a gasket bonded to the section, with the gasket enclosing the section of the flexible printed circuit board and being formed by placing the section of the flexible printed circuit board in a molding fixture, injecting a fluid into the molding fixture, curing the fluid, and removing the molding fixture from the section of the flexible printed circuit board.

### Example 19

The device of Example 18, where the gasket may provide water ingress protection for the section of the flexible printed circuit board.

### Example 20

The device of any of Examples 18 and 19, where the gasket may provide dust ingress protection for the section of the flexible printed circuit board.

### Example 21

The device of any of Examples 18, 19, or 20, where the flexible printed circuit board may include at least one wing in the section of the flexible printed circuit board included in the gasket.

### Example 22

The device of Example 21, where the at least one wing may improve a retention of the gasket to the flexible printed circuit board.

### Example 23

The device of any of Examples 21 or 22, where the at least one wing may improve an alignment of the gasket with the flexible printed circuit board.

### Example 24

The device of any of Examples 21-23, where the at least one wing may create a tortuous path for the travel of water.

### Example 25

The device of any of Examples 18-24, where a portion of the section of the flexible printed circuit board may include an upper surface of the flexible printed circuit board and a lower surface of the flexible printed circuit board.

### Example 26

The device of any of Examples 18-25, where additional materials may be deposited on the upper surface of the portion of the section of the flexible printed circuit board and the lower surface of the portion of the section of the flexible printed circuit board, the additional materials improving the bond formed between the gasket and the flexible printed circuit board.

### Example 27

The device of any of Examples 18-25, where a roughness of the upper surface of the portion of the section of the flexible printed circuit board and the lower surface of the portion of the section of the flexible printed circuit board are increased, improving the bond formed between the gasket and the flexible printed circuit board.

### Example 28

The device of any of Examples 18-27, where the device may be an enclosure including an upper part and a lower part.

### Example 29

The device of any of Examples 18-28, where the gasket may include at least one row of compressible ribs.

### Example 30

The device of Example 29, where the at least one row of compressible ribs may provide a seal between the upper part of the enclosure and the lower part of the enclosure when the gasket is placed in the enclosure.

### Example 31

The device of any of Examples 29 or 30, where the at least one row of compressible ribs may prevent rotation of the section of the flexible printed circuit board in the enclosure when the gasket is placed in the enclosure.

### Example 32

The device of any of Examples 18-31, where the flexible printed circuit board may include at least one alignment mark, and where placing the section of the flexible printed circuit board in the molding fixture includes the use of the at least one alignment mark.

### Example 33

The device of any of Examples 18-32, where injecting the fluid into the molding fixture occurs at an ambient temperature.

### Example 34

The device of any of Examples 18-33, where curing the fluid occurs at an ambient temperature.

### Example 35

The device of any of Examples 18-34, where forming the gasket may involve the use of form-in-place gasket technology.

### Example 36

The device of any of Examples 18-35, where the device is a wearable electronic device.

### Example 37

The device of Example 18-36, where the wearable electronic device may include at least one end piece, and where the section of the flexible printed circuit board may be located in the end piece.

### Example 38

The device of Example 18-37, where the at least one end piece may include a hinge, and where the gasket may be placed over the hinge allowing the section of the flexible printed circuit board to flex with the rotation of the hinge.

### Example 39

The device of any of Examples 18-38, where the wearable electronic device may be an eyewear device of an augmented reality system.

### Example Systems and Methods for Enhancing Remote or Virtual Social Experiences Using Biosignals

Existing remote conferencing tools typically use video and audio streaming to facilitate remote communications. However, real-life interactions often include physical interactions that involve coordinated movements of two or more individuals and often involve direct touch (e.g., handshakes) and/or indirect touch (e.g., mutual contact with objects in the individuals' surroundings). Such physical interactions may strongly contribute to emotions related to those real-life interactions and/or may help form memories of such real-life interactions. The lack of an ability to transmit physical movements to others in existing remote conferencing tools may cause the socialization experiences provided by these tools to be very limited in comparison to similar real-life socialization experiences.

The present disclosure is generally directed to using biosignals (e.g., Electromyography (EMG) signals, surface Electromyography (sEMG) signals, Electrooculography (EOG) signals, Electroencephalography (EEG) signals, Electrocardiography (ECG) signals, etc.) to enhance socialization experiences between two or more users involved in a remote conference and/or other types of remote and/or virtual interactions. In some embodiments, EMG sensors may be used to read out muscular activation patterns that may be used to control virtual objects.

In one embodiment, a participating user may wear a wrist-wearable EMG sensing device that reads out activations and/or activation patterns of the muscles or motor units controlling one hand. The wrist-wearable EMG sensing device may convert these activations and/or patterns into force vectors and transmit them via a communicating device or system, such as the Internet, to a server computer hosting a physics engine. The physics engine may use the force vectors to control a virtual object, which may be subject to a virtual gravity, such that the object can therefore be moved and rotated in space by the participating user. Another participating user may also wear a similar EMG sensing device and may also control the object through forces determined via EMG signals. In some embodiments, the cooperation of the participating users may allow for socialization experiences through muscle activation (e.g., to balance an object on a cusp).

Embodiments of this disclosure may enable physical interaction between remote parties in a virtual or extended reality environment, especially coordinated movements involving direct touch (e.g., handshakes) and/or indirect touch (e.g., through mutual contact with virtual objects). For example, embodiments of this disclosure may enable physical games (e.g., virtual tug of war or cooperation to balance a large “heavy” object) or other remote interaction activities requiring shared physical effort such as shaking hands through a common EMG-controlled virtual object.

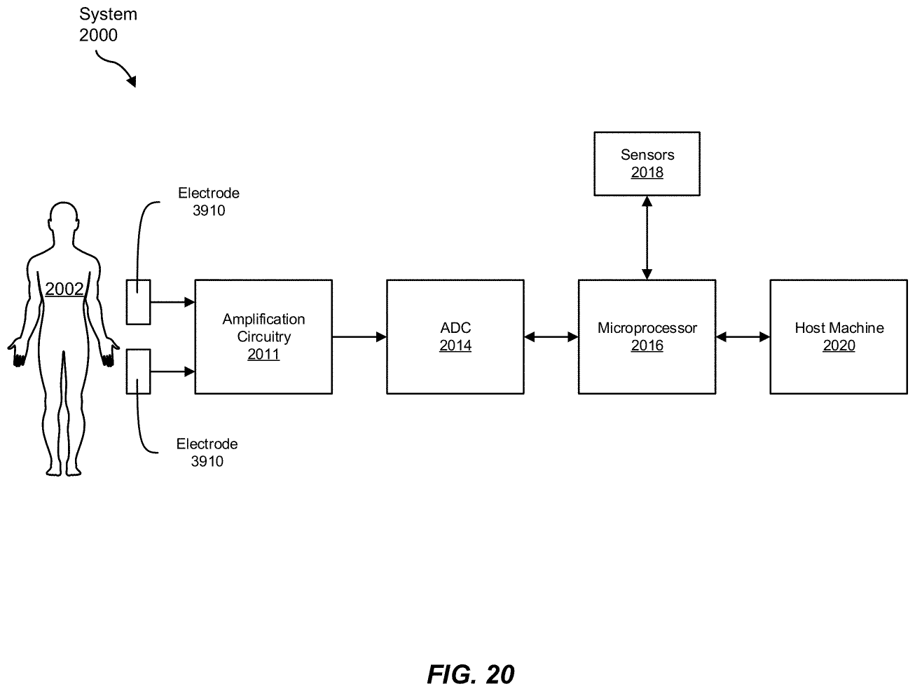

FIG. 20 schematically illustrates components of a biosignal sensing system 2000 in accordance with some embodiments. System 2000 includes a pair of electrodes 2010 (e.g., a pair of dry surface electrodes) configured to register or measure a biosignal (e.g., an Electrooculography (EOG) signal, an Electromyography (EMG) signal, a surface Electromyography (sEMG) signal, an Electroencephalography (EEG) signal, an Electrocardiography (ECG) signal, etc.) generated by the body of a user 2002 (e.g., for electrophysiological monitoring or stimulation). In some embodiments, both of electrodes 2010 may be contact electrodes configured to contact a user's skin. In other embodiments, both of electrodes 2010 may be non-contact electrodes configured to not contact a user's skin. Alternatively, one of electrodes 2010 may be a contact electrode configured to contact a user's skin, and the other one of electrodes 2010 may be a non-contact electrode configured to not contact the user's skin. In some embodiments, electrodes 2010 may be arranged as a portion of a wearable device configured to be worn on or around part of a user's body. For example, in one nonlimiting example, a plurality of electrodes including electrodes 2010 may be arranged circumferentially around an adjustable and/or elastic band such as a wristband or armband configured to be worn around a user's wrist or arm (e.g., as illustrated in FIG. 2). Additionally or alternatively, at least some of electrodes 2010 may be arranged on a wearable patch configured to be affixed to or placed in contact with a portion of the body of user 2002. In some embodiments, the electrodes may be minimally invasive and may include one or more conductive components placed in or through all or part of the skin or dermis of the user. It should be appreciated that any suitable number of electrodes may be used, and the number and arrangement of electrodes may depend on the particular application for which a device is used.

Biosignals (e.g., biopotential signals) measured or recorded by electrodes 2010 may be small, and amplification of the biosignals recorded by electrodes 2010 may be desired. As shown in FIG. 20, electrodes 2010 may be coupled to amplification circuitry 2011 configured to amplify the biosignals conducted by electrodes 2010. Amplification circuitry 2011 may include any suitable amplifier. Examples of suitable amplifiers may include operational amplifiers, differential amplifiers that amplify differences between two input voltages, instrumental amplifiers (e.g., differential amplifiers having input buffer amplifiers), single ended amplifiers, and/or any other suitable amplifier capable of amplifying biosignals.

As shown in FIG. 20, an output of amplification circuitry 2011 may be provided to analog-to-digital converter (ADC) circuitry 2014, which may convert amplified biosignals to digital signals for further processing by a microprocessor 2016. In some embodiments, microprocessor 2016 may process the digital signals to enhance remote or virtual social experiences (e.g., by converting or transforming the biosignals into an estimation of a spatial relationship of one or more skeletal structures in the body of user 2002 and/or a force exerted by at least one the skeletal structures in the body of user 2002), as will be explained in greater detail below. Microprocessor 2016 may be implemented by one or more hardware processors. In some embodiments, electrodes 2010, amplification circuitry 2011, ADC circuitry 2014, and/or microprocessor 2016 may represent some or all of a single biosignal sensor. The processed signals output from microprocessor 2016 may be interpreted by a host machine 2020, examples of which include, but are not limited to, a desktop computer, a laptop computer, a smartwatch, a smartphone, a head-mounted display device, or any other computing device. In some implementations, host machine 2020 may be configured to output one or more control signals for controlling a physical or virtual device or object based, at least in part, on an analysis of the signals output from microprocessor 2016. As shown, biosignal sensing system 2000 may include additional sensors 2018, which may be configured to record types of information about a state of a user other than biosignal information. For example, sensors 2018 may include, temperature sensors configured to measure skin/electrode temperature, inertial measurement unit (IMU) sensors configured to measure movement information such as rotation and acceleration, humidity sensors, and other bio-chemical sensors configured to provide information about the user and/or the user's environment.

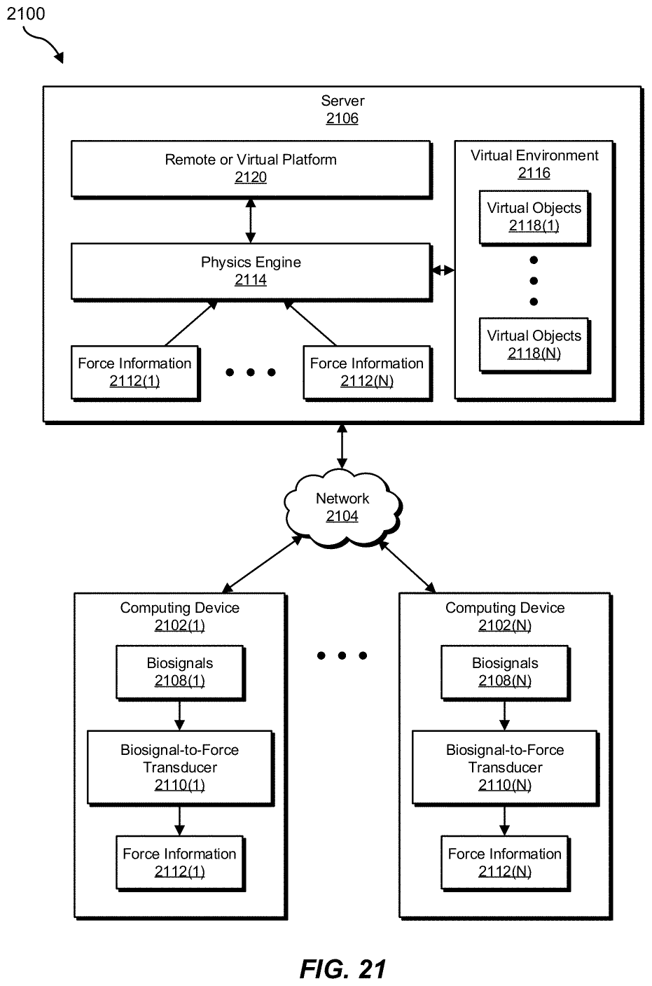

Example system 2000 in FIG. 20 may be implemented in a variety of ways. For example, all or a portion of example system 2000 may represent portions of an example system 2100 in FIG. 21. As shown, system 2100 may include computing devices 2102(1)-(N) in communication with a server 2106 via a network 2104. Computing devices 2102(1)-(N) generally represent any type or form of computing device capable of reading computer-executable instructions and/or measuring users biosignals. Examples of computing devices 2102(1)-(N) include vibrotactile system 1200 in FIG. 12, haptic device 1304 in FIG. 13, and/or haptic device 1430 in FIG. 14. Additional examples of computing devices 2102(1)-(N) include, without limitation, laptops, tablets, desktops, servers, cellular phones, Personal Digital Assistants (PDAs), multimedia players, embedded systems, wearable devices (e.g., smart watches, smart glasses, etc.), gaming consoles, variations or combinations of one or more of the same, and/or any other suitable computing device. As shown in FIG. 21, each of computing devices 2102(1)-(N) may include a biosignal-to-force transducer that converts biosignals 2108 from a user to force information 2112 describing forces exerted by a user. While not illustrated in this figure, each of computing devices 2102(1)-(N) may also include a biosignal-to-position transducer that converts biosignals 2108 from a user to position information describing positionings of a user's body.

Server 2106 generally represents any type or form of computing device that is capable of hosting remote or virtual social experiences and/or enhancing remote or virtual social experiences using biosignals. In some embodiments, server 2106 may represent one or more servers hosting an extended-reality conference or interaction between two or more individuals. Additional examples of server 2106 include, without limitation, security servers, application servers, web servers, storage servers, and/or database servers configured to run certain software applications and/or provide various security, web, storage, and/or database services. Although illustrated as a single entity in FIG. 21, server 2106 may include and/or represent a plurality of servers that work and/or operate in conjunction with one another. As shown in FIG. 21, server 2106 may include a remote or virtual platform 2120 (e.g., a conferencing or gaming platform) that implements a virtual environment 2116 having one or more virtual objects 2118(1)-(N). In this example, a physics engine 2114 may provide an approximate simulation of virtual environment 2116, such as rigid body dynamics (including collision detection and movement of interconnected bodies under the action of external forces). As shown, physics engine 2114 may update the simulation of virtual environment 2116 based on force information 2112(1)-(N) derived from biosignals. While not illustrated in this figure, physics engine 2114 may also update the simulation of virtual environment 2116 based on position information derived from biosignals.

Network 2104 generally represents any medium or architecture capable of facilitating communication or data transfer. In one example, network 2104 may facilitate communication between computing devices 2102(1)-(N) and server 2106. In this example, network 2104 may facilitate communication or data transfer using wireless and/or wired connections. Examples of network 2104 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

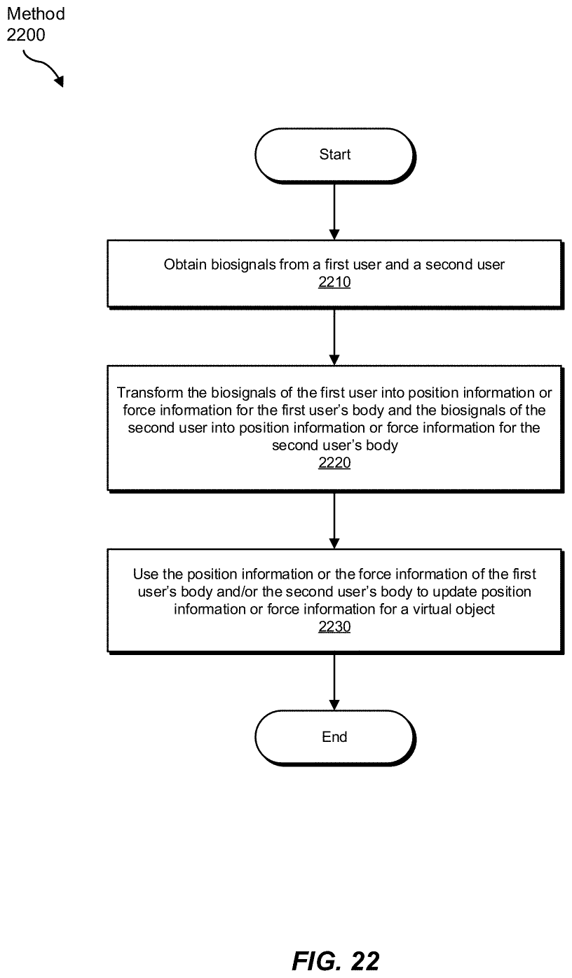

FIG. 22 is a flow diagram of an exemplary computer-implemented method 2200 for enhancing remote or virtual social experiences using biosignals. The steps shown in FIG. 22 may be performed by any suitable computer-executable code and/or computing system, including the devices illustrated in FIGS. 20, 21, and/or 23. In one example, each of the steps shown in FIG. 22 may represent an algorithm whose structure includes and/or is represented by multiple sub-steps, examples of which will be provided in greater detail below.

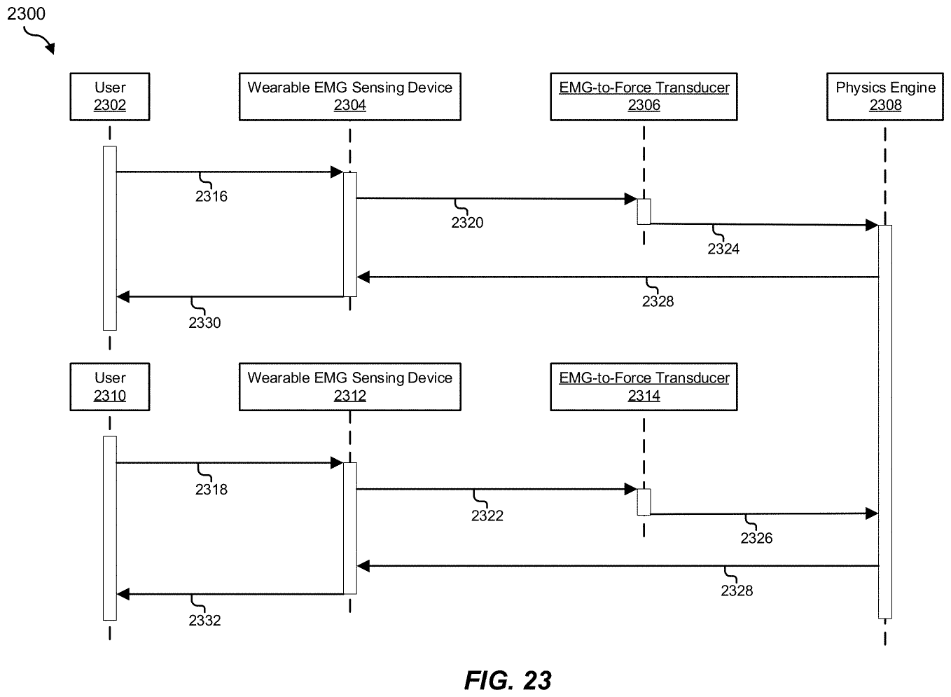

As illustrated in FIG. 22, at step 2210 one or more of the systems described herein may obtain biosignals from a first user and a second user. For example, computing device 2102(1) in FIG. 21 may obtain biosignals 2108(1) from a user of computing device 2102(1), and computing device 2102(N) in FIG. 21 may obtain biosignals 2108(N) from a user of computing device 2102(N). In another example, a wearable EMG sensing device 2304 in FIG. 23 may obtain biosignals 2316 from a user 2302, and a wearable EMG sensing device 2312 in FIG. 23 may obtain biosignals 2318 from a user 2310. Additionally or alternatively, an EMG-to-force transducer 2306 in FIG. 23 may receive EMG signals 2316 and/or biosignal information 2320 derived from EMG signals 2316 from wearable EMG sensing device 2304, and an EMG-to-force transducer 2314 in FIG. 23 may receive EMG signals 2318 and/or biosignal information 2322 derived from EMG signals 2318 from wearable EMG sensing device 2312.

Returning to FIG. 22 at step 2220, one or more of the systems described herein may transform the biosignals of the first user into position information or force information for the first user's body and the biosignals of the second user into position information or force information for the second user's body. For example, biosignal-to-force transducer 2110(1) may, as part of computing device 2102(1), transform biosignals 2108(1) into force information 2112(1), and biosignal-to-force transducer 2110(N) may, as part of computing device 2102(N), transform EMG signals 2108(N) into force information 2112(N). In another example, EMG-to-force transducer 2306 may transform EMG signals 2316 and/or biosignal information 2320 derived from EMG signals 2316 into force information 2324, and EMG-to-force transducer 2314 may transform EMG signals 2318 and/or biosignal information 2322 derived from EMG signals 2318 into force information 2326.

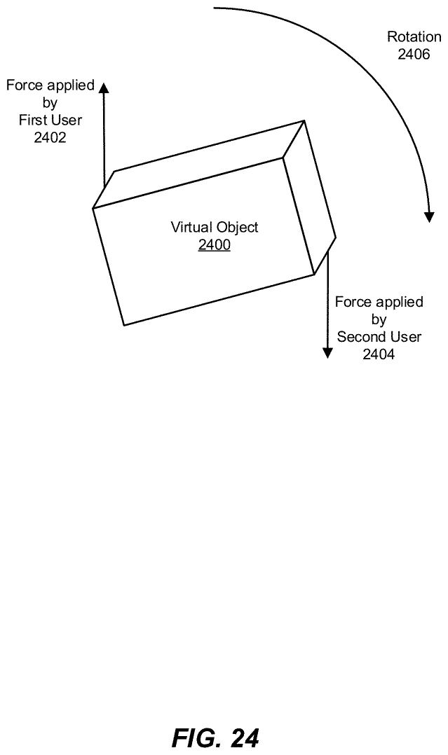

Returning to FIG. 22 at step 2230, one or more of the systems described herein may use the position information or the force information of the first user's body and/or the second user's body to update position information or force information for a virtual object. For example, physics engine 2114 may, as part of server 2106 in FIG. 21, update position information and/or force information of virtual objects 2118(1)-(N) within virtual environment 2116 based on force information 2112(1)-(N). In another example, physics engine 2308 in FIG. 23 may update the position or force information associated with one or more virtual objects with which user 2302 and 2310 interact based on force information 2324 and 2326. For example, physics engine 2308 may update position information and/or force information (e.g., a rotation 2406) of a virtual object 2400 in FIG. 24 based on forces 2402 (e.g., a force applied by user 2302) and 2404 (e.g., a force applied by user 2310). In the example shown in FIG. 23, physics engine 2308 may provide updated position information and/or force information 2328 to wearable EMG sensing devices 2304 and 2312 for providing visual or haptic feedback 2330 and 2332 to users 2302 and 2310.

### Example Embodiments

### Example 40

A computer-implemented method for enhancing remote or virtual social experiences using biosignals may include (1) obtaining biosignals from a first user, (2) obtaining biosignals from a second user, (3) transforming the biosignals of the first user into position information or force information for the first user's body, (4) transforming the biosignals of the second user into position information or force information for the second user's body, and (5) updating position information or force information for a virtual object based on the position information or the force information of the first user's body and/or the position information or the force information of the second user's body.

### Example 41

The computer-implemented method of Example 40, wherein the biosignals from the first user and the biosignals from the second user are electromyography signals.

### Example 42

The computer-implemented method of any of Examples 40 or 41, further including displaying the virtual object to the first user or the second user after updating the position information or the force information for the virtual object.

### Example 43

The computer-implemented method of any of Examples 40-42, further including providing haptic feedback associated with the virtual object to the first user or the second user after updating the position information or the force information for the virtual object.

### Example 44

A computer-implemented method for enhancing remote or virtual social experiences using biosignals may include (1) obtaining biosignals from a first user, (2) obtaining biosignals from a second user, (3) transforming the biosignals of the first user into force information for the first user's body, (4) transforming the biosignals of the second user into force information for the second user's body, and (5) updating position information or force information for a virtual object based on the force information of the first user's body and/or the force information of the second user's body.

### Example 45

The computer-implemented method of Example 44, wherein the biosignals from the first user and the biosignals from the second user are electromyography signals.

### Example 46

The computer-implemented method of any of Examples 44 or 45, further including displaying the virtual object to the first user or the second user after updating the position information or the force information for the virtual object.

### Example 47

The computer-implemented method of any of Examples 44-46, further including providing haptic feedback associated with the virtual object to the first user or the second user after updating the position information or the force information for the virtual object.

### Example 48

A computer-implemented method for enhancing remote or virtual social experiences using biosignals may include (1) hosting a virtual environment for a first user and a second user, the virtual environment having at least one virtual object with which the first user and the second user may simultaneously interact, (2) receiving, while the first user interacts with the at least one virtual object, position information or force information for the first user's body, the position information or the force information for the first user's body having been derived from biosignals obtained from the first user's body, (3) receiving, while the second user interacts with the at least one virtual object, position information or force information for the second user's body, the position information or the force information for the second user's body having been derived from biosignals obtained from the second user's body, and (4) updating position information or force information for the at least one virtual object based on the position information or the force information of the first user's body and/or the position information or the force information of the second user's body.

### Example 49

The computer-implemented method of Example 48, wherein the biosignals from the first user and the biosignals from the second user are electromyography signals.

### Example 50

The computer-implemented method of any of Examples 48 or 49, further including displaying the virtual object to the first user or the second user after updating the position information or the force information for the virtual object.

### Example 51

The computer-implemented method of any of Examples 48-50, further including providing haptic feedback associated with the virtual object to the first user or the second user after updating the position information or the force information for the virtual object.

### Example 52

A system for enhancing remote or virtual social experiences using biosignals may include at least one physical processor and physical memory storing computer-executable instructions that, when executed by the physical processor, cause the physical processor to (1) obtain biosignals from a first user, (2) obtain biosignals from a second user, (3) transform the biosignals of the first user into position information or force information for the first user's body, (4) transform the biosignals of the second user into position information or force information for the second user's body, and (5) update position information or force information for a virtual object based on the position information or the force information of the first user's body and/or the position information or the force information of the second user's body.

### Example 53

A system for enhancing remote or virtual social experiences using biosignals may include at least one physical processor and physical memory storing computer-executable instructions that, when executed by the physical processor, cause the physical processor to (1) host a virtual environment for a first user and a second user, the virtual environment having at least one virtual object with which the first user and the second user may simultaneously interact, (2) receive, while the first user and the second user interact with the at least one virtual object, position information or force information for the first user's body, the position information or the force information for the first user's body having been derived from biosignals obtained from the first user's body, (3) receive, while the first user and the second user interact with the at least one virtual object, position information or force information for the second user's body, the position information or the force information for the second user's body having been derived from biosignals obtained from the second user's body, and (4) update position information or force information for the at least one virtual object based on the position information or the force information of the first user's body and/or the position information or the force information of the second user's body.

Split Device with Identity Fixed to Physical Location

Devices that are related to physical locations may typically have identity data stored as a part of the device. However, when such a device suffers from part failures, requires battery charging in case of low battery, or otherwise requires maintenance, the device may be removed and replaced with a temporary or permanent replacement device. The new device may require reconfiguration with the same identity data.

For example, a device that serves as a booking system for a conference room may store identity data that includes the conference room's name and/or location, which applications to load, or other configuration data directly tied to the location, etc. The device may be located on a mount near a doorway of the conference room to act as a digital sign. The device may include a non-removable battery, which may be desirable due to cost, physical device size, etc., such that recharging the device may require removing the device from the location. To prevent the conference room from being left without a booking tool, a similar replacement device may be installed in the mount. However, such devices are often not preconfigured with identity data as the installation location may not be known beforehand. Thus, the replacement device may need to be reconfigured with the identity data. Reconfiguring the replacement device may require an installer to have access to reconfiguring the device, as well as knowledge of the specific identity data.

The present disclosure is generally directed to a split device having identity data that is fixed to a physical location. As will be explained in greater detail below, embodiments of the present disclosure may store configuration data, which may be associated with a location, in a mount device separate from a configurable device. The mount device may be affixed to a fixed surface at the location and may further hold the configurable device. The configuration data may persist such that the configurable device may be removed (e.g., for maintenance) without losing the configuration data. Advantageously, a replacement device may be configured with the same configuration data by connecting with the mount device without requiring manual reconfiguration of the replacement device.

Features from any of the embodiments described herein may be used in combination with one another in accordance with the general principles described herein. These and other embodiments, features, and advantages will be more fully understood upon reading the following detailed description in conjunction with the accompanying drawings and claims.

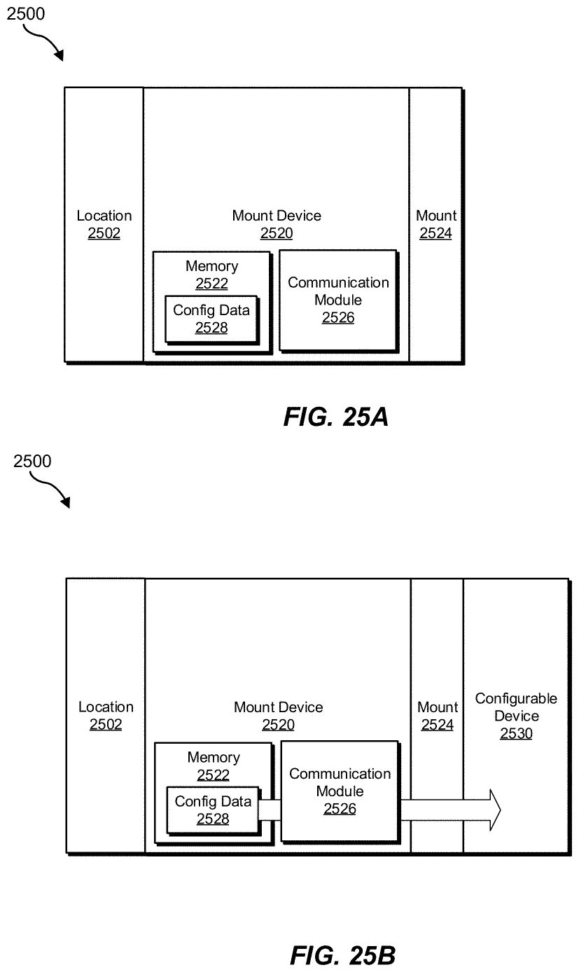

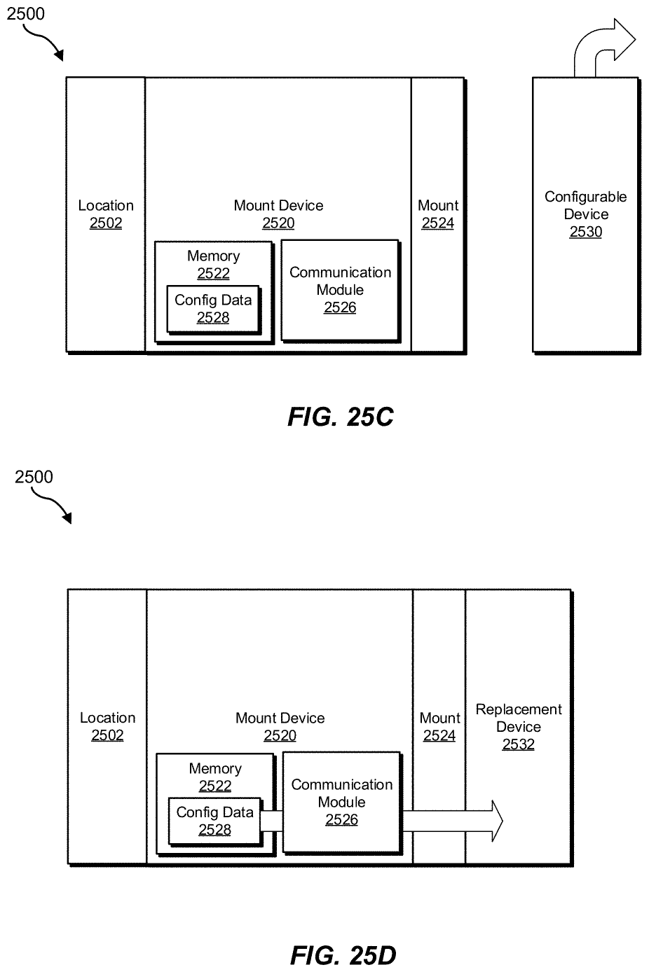

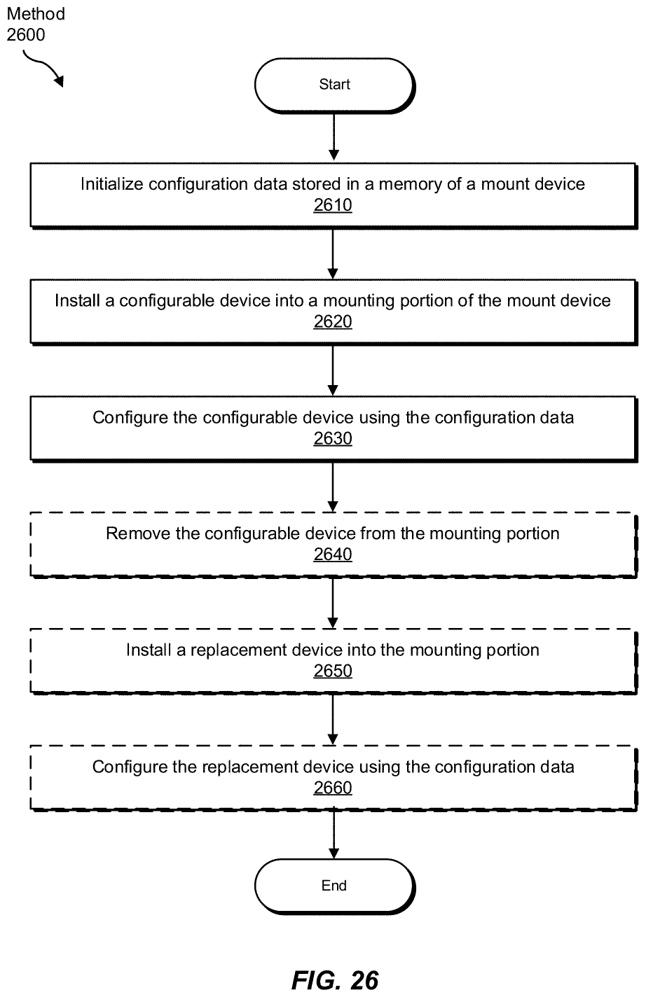

The following will provide, with reference to FIGS. 25A-25D, detailed descriptions of a split device with identity fixed to a physical location. Descriptions of installing and configuring devices are provided with reference to FIGS. 25A-25D. Detailed descriptions of a method for using the split device are provided with reference to FIG. 26.

FIG. 25A shows a block diagram of a system 2500 that may include a mount device 2520 that may be attached to a fixed surface of a location 2502. Mount device 2520 may include a memory 2522 for storing configuration data 2528, a communication module 2516, and a mount 2524. Mount device 2520 may be a computing device, although in some examples mount device 2520 may not be capable of functioning independently.

Mount device 2520 may be effectively permanently affixed to location 2502. For example, mount device 2520 may be screwed into or otherwise attached to a wall surface, doorway, post, or other permanent structure at location 2502. Mount device 2520 may not be readily removed or may otherwise be intended to remain at location 2502. In some examples, mount device 2520 may receive power from a power supply at location 2502. In other examples, mount device 2520 may have its own power source (e.g., battery, solar panel, etc.). In yet other examples, mount device 2520 may receive power from an attached configurable device 2530. As will be explained further below, mount device may hold, using mount 2524, a configurable device 2530 (see, e.g., FIGS. 25B and 25C). Memory 2522 may be a physical memory that stores configuration data 2528. Configuration data 2528 may be static data. For instance, configuration data 2528 may not be changed or may be changed infrequently. In some examples, memory 2522 may include non-volatile memory.

Configuration data 2528 may be programmed during an installation of mount device 2520 at location 2502. In some examples, configuration data 2528 may be permanently stored in memory 2522. Configuration data 2528 may include data associated with location 2502. For example, configuration data 2528 may include identity or identification data relating to a location name for location 2502, location data of location 2502 (e.g., map data, relative location data, landmark data, etc.). Configuration data 2528 may also include data for configuring configurable device 2530. For example, configuration data 2528 may include application data (e.g., settings, profiles, state data, etc.), data for initializing configurable device 2530, data for initializing an application on configurable device 2530, etc. In some examples, configuration data 2528 may include instructions and/or programs for initializing and/or configuring configurable device 2530.

Communication module 2526 may include software and/or hardware interfaces for communicatively coupling mount device 2520 with configurable device 2530. More specifically, communication module 2526 may enable data (e.g., configuration data 2528) to be transferred from and/or to memory 2522. In some examples, communication module 2526 may include an electrical connector. For example, the electrical connector may be a port that mates with an appropriate port on configurable device 2530. In some examples, the electrical connector may be integrated with mount 2524 such that when configurable device 2530 is installed into mount 2524, the electrical connection may be made. For instance, communication module 2526 may include spring fingers for connecting with an appropriate port on configurable device 2530. In other examples, communication module 2526 may include a wireless connection (e.g., including transmitters and receivers) for wirelessly communicating with configurable device 2530.

FIG. 25B illustrates configurable device 2530 installed into mount device 2520. Configurable device 2530 may be a computing device configured specifically for use at location 2502. For example, configurable device 2530 may be one or more of a digital sign (e.g., displaying information about location 2502), a booking system (e.g., a system for showing reservations for location 2502), a wayfinder device (e.g., for displaying navigation information and/or specific information about location 2502), a smart bus-stop sign (e.g., for displaying route information and updates), or other similar device with location-specific functionality.

As seen in FIG. 25B, configurable device 2530 may be installed into mount device 2520 using mount 2524. Mount 2524 may include physical connectors, such as latches, hooks, tabs, notches, etc., for holding configurable device 2530 securely. In some examples, mount 2524 may include a locking feature to prevent unauthorized removal of configurable device 2530.

Configurable device 2530 may connect, either wired or wirelessly, with mount device 2520. For instance, configurable device 2530 may restart after being fitted into mount 2524 and establish a connection with mount device 2520. Configurable device 2530 may read configuration data 2528 from memory 2522 via communication module 2526. For example, configurable device 2530 may copy configuration data 2528 into its own memory (not shown in FIGS. 25B-C). In some examples, configurable device 2530 may execute portions of configuration data 2528. In yet other examples, mount device 2520 may perform initialization and/or configuration of replacement device 2532 using configuration data 2528.

FIG. 25C illustrates removal of configurable device 2530. Configurable device 2530 may be removed for various reasons, such as for maintenance. For example, configurable device 2530 may include a non-removable battery that may require configurable device 2530 to be removed from location 2502 to be recharged. Alternatively, configurable device 2530 may need to be removed for repair of broken or worn parts. In other examples, configurable device 2530 may be removed for upgrading to a newer device.

FIG. 25D illustrates installation of a replacement device, replacement device 2532. In some examples, replacement device 2532 may be another one of configurable device 2530. In other examples, replacement device 2532 may be a different device with similar functionalities as configurable device 2530. For example replacement device 2532 may be a different version (e.g., an upgraded version, an older version, etc.) or may be a completely different device that may be compatible with mount device 2520.

Similar to FIG. 25B, in FIG. 25D replacement device 2532 may be fitted into mount device 2520 using mount 2524. Replacement device 2532 may connect, via communication module 2526, to mount device 2520 to access configuration data 2528. Replacement device 2532 may be configured, using configuration data 2528, similar to configurable device 2530 as described above. Thus, replacement device 2532 may replicate configurable device 2530 that was replaced.

FIG. 26 is a flow diagram of an exemplary computer-implemented method 2600 for using a split device with identity fixed to a physical location. The steps shown in FIG. 26 may be performed by any suitable computer-executable code and/or computing system, including the system(s) illustrated in FIGS. 25A-D. In one example, each of the steps shown in FIG. 26 may represent an algorithm whose structure includes and/or is represented by multiple sub-steps, examples of which will be provided in greater detail below.

As illustrated in FIG. 26, at step 2610 one or more of the systems described herein may initialize configuration data stored in a memory of a mount device. For example, configuration data 2528, stored in memory 2522 of mount device 2520, may be initialized.

The systems described herein may perform step 2610 in a variety of ways. In one example, a user may, after installing mount device 2520 at location 2502, manually configure configuration data 2528. For example, the user may enter the appropriate data for saving in memory 2522. In other examples, the user may transfer configuration data 2528, for example using a computing device capable of connecting to mount device 2520 via communication module 2526, into memory 2522. Because location 2502 for mount device 2520 may not be known until mount device 2520 is installed, mount device 2520 may not have configuration data 2528 pre-installed.

At step 2620 one or more of the systems described herein may install a configurable device into a mounting portion of the mount device. For example, configurable device 2530 may be installed into mount 2524 of mount device 2520, as seen in FIG. 25B.

The systems described herein may perform step 2620 in a variety of ways. In one example, configurable device 2530 may engage mount 2524, such as spring fingers of mount 2524. For instance, the user may insert configurable device 2530 into mount 2524. In some examples, configurable device 2530 may further be locked into mount device 2520.

At step 2630 one or more of the systems described herein may configure the configurable device using the configuration data. For example, configurable device 2530 may be configured using configuration data 2528, as seen in FIG. 25B.

The systems described herein may perform step 2630 in a variety of ways. In one example, the user may instruct configurable device 2530 to connect to mount device 2520 and read configuration data 2528. Configurable device 2530 may further configure itself as needed, as described above. In some examples, configurable device 2530 may write additional data into memory 2522. For example, configurable device 2530 may write status updates (e.g., success and/or failure of configuration), update statistics (e.g., number of devices connected, timestamps, etc.), and/or other data as needed. In some examples, configurable device 2530 may provide updates to configuration data 2528.

Optionally, at step 2640 one or more of the systems described herein may remove the configurable device from the mounting portion. For example, configurable device 2530 may be removed from mount 2524, as seen in FIG. 25C.

The systems described herein may perform step 2640 in a variety of ways. In one example, the user may remove configurable device 2530 for maintenance reasons, as described above. The user may disengage mount 2524 and, when locked, unlock configurable device 2530 from mount device 2520. The user may then take configurable device 2530 away from location 2502 to perform maintenance as needed.

Optionally, at step 2650 one or more of the systems described herein may install a replacement device into the mounting portion. For example, replacement device 2532 may be installed into mount 2524, as seen in FIG. 25D.

The systems described herein may perform step 2650 in a variety of ways. In one example, the user may install replacement device 2532 into mount 2524, similar to configurable device 2530 as described above.

Optionally, at step 2660 one or more of the systems described herein may configure the replacement device using the configuration data. For example, replacement device 2532 may be configured using configuration data 2528 in order to replicate configurable device 2530, as seen in FIG. 25D.

The systems described herein may perform step 2660 in a variety of ways. In one example, replacement device 2532 may connect, via communication module 2526, to mount device 2520 to read configuration data 2528. Similar to configurable device 2530 described above, replacement device 2532 may be configured using configuration data 2528.

Conventional devices that are related to physical locations typically have identity data stored with the device. Replacing such a device requires setting up the same identity data in the replacement device, which adds complexity and added risk of errors. The present disclosure describes splitting the functionalities into two devices, a generic device and a separate mount that contains electronics for storing non-changing configuration data. Because the configuration data is specific to a single device, any generic device fitted into the mount may read and self-configure correctly without requiring installers to have any specialist knowledge and/or skills. The connection may be electrical (e.g., using spring fingers) or wireless (e.g., using near-field communication). Thus, devices that have failed or requires recharging may be replaced with a working, fully charged device without requiring complicated re-setup. In addition, installers may not require additional training and/or granted permissions to be able to setup such devices. For example, mount locations may be pre-configured, and the devices may be installed at a later date.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

### Example Embodiments

### Example 54

A mount device including (i) a physical memory storing configuration data associated with a location of the mount device, (ii) a mounting portion for holding a configurable device, and (iii) a communication module for communicatively coupling the mount device and the configurable device.

### Example 55

The mount device of example 54, where the configuration data includes at least one of a location name, location data, or application data.

### Example 56

The mount device of examples 54 and 55, where the configuration data is static data.

### Example 57

The mount device of examples 54-56, where the communication module includes an electrical connector.

### Example 58

The mount device of examples 54-57, where the electrical connector is integrated with the mounting portion.

### Example 59

The mount device of examples 54-58, where the mounting portion includes spring fingers for connecting with the configurable device.

### Example 60

The mount device of examples 54-59, where the communication module comprises a wireless connection.

### Example 61

A system including a configurable device and a mount device including: (i) a physical memory storing configuration data associated with a location of the mount device, (ii) a mounting portion for holding the configurable device, and (iii) a communication module for communicatively coupling the mount device and the configurable device.

### Example 62

The system of example 61, where the configuration data includes at least one of a location name, location data, or application data.

### Example 63

The system of any of examples 61 and 62, where the configuration data includes data for initializing the configurable device.

### Example 64

The system of any of examples 61-63, where the configuration data comprises data for initializing an application on the configurable device.

### Example 65

The system of any of examples 61-64, where the configuration data is static data.

### Example 66

The system of any of examples 61-65, where the communication module includes an electrical connector.

### Example 67

The system of any of examples 61-66, where the electrical connector is integrated with the mounting portion.

### Example 68

The system of any of examples 61-67, where the mounting portion includes spring fingers for connecting with the configurable device.

### Example 69

The system of any of examples 61-68, wherein the communication module includes a wireless connection.

### Example 70

The system of any of examples 61-69, where the configurable device includes at least one of a digital sign, a booking system, a wayfinder device, or a smart bus-stop sign.

### Example 71

The system of any of examples 61-70, where the configurable device comprises a non-removable battery.

### Example 72

A method including: (i) initializing configuration data stored in a memory of a mount device, (ii) installing a configurable device into a mounting portion of the mount device, and (iii) configuring the configurable device using the configuration data.

### Example 73

The method of example 72 may further include removing the configurable device from the mounting portion, installing a replacement device into the mounting portion, and configuring the replacement device using the configuration data.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A method comprising:
a processor;
a memory device comprising instructions that, when executed by the processor, perform at least one of:
a process for enhancing remote or virtual social experiences using biosignals comprising:
obtaining biosignals from a first user;
obtaining biosignals from a second user;
transforming the biosignals of the first user into position information or force information for the first user's body;
transforming the biosignals of the second user into position information or force information for the second user's body; and
updating position information or force information for a virtual object based on at least one of the position information or the force information of the first user's body or the position information or the force information of the second user's body; or
an additional process for enhancing remote or virtual social experiences using biosignals comprising:
hosting a virtual environment for the first user and the second user, the virtual environment having at least one virtual object with which the first user and the second user may simultaneously interact;
receiving, while the first user interacts with the at least one virtual object, position information or force information for the first user's body, the position information or the force information for the first user's body having been derived from biosignals obtained from the first user's body;
receiving, while the second user interacts with the at least one virtual object, position information or force information for the second user's body, the position information or the force information for the second user's body having been derived from biosignals obtained from the second user's body; and
updating position information or force information for the at least one virtual object based on at least one of the position information or the force information of the first user's body or the position information or the force information of the second user's body; or
a process for configuring data comprising:
initializing configuration data stored in a memory of a mount device;
installing a configurable device into a mounting portion of the mount device; and
configuring the configurable device using the configuration data.

2. A system comprising at least one of:
a shock absorbing device comprising:
a shock absorbing material and an adhesive material, wherein the shock absorbing material is shaped and configured to partially surround an image sensor and the adhesive material is positioned and configured to secure the shock absorbing material to the image sensor; or
a mount device comprising:
a physical memory storing configuration data associated with a location of the mount device;
a mounting portion for holding a configurable device; and
a communication module for communicatively coupling the mount device and the configurable device; or
a circuit board enclosure device comprising:
a flexible printed circuit board comprising at least one section and a gasket bonded to the section, the gasket enclosing the section of the flexible printed circuit board and being formed by:
placing the section of the flexible printed circuit board in a molding fixture;
injecting a fluid into the molding fixture;
curing the fluid; and
removing the molding fixture from the section of the flexible printed circuit board.

3. The system of claim 2, wherein, when an impact force is imparted to the image sensor, the shock-absorbing material is configured to transfer the impact force to a base of the image sensor.

4. The system of claim 2, wherein the shock-absorbing material is configured to absorb an impact force imparted to the image sensor.

5. The system of claim 4, wherein absorbing the impact force imparted to the image sensor comprises distributing the impact force across the shock-absorbing material.

6. The system of claim 2, wherein the shock-absorbing material is configured to substantially maintain a structural integrity of the image sensor when an impact force is imparted to the image sensor.

7. The system of claim 2, wherein the shock-absorbing material comprises at least one of:
a polymer material;
an elastomer;
a plastic;
a polyethylene material;
a polycarbonate material;
an acrylonitrile butadiene styrene material;
a visco-elastic polymer material;
a polymer matrix composite material;
a fiber-reinforced polymer composite material;
a polyurethane material;
a butyl rubber material; or
a neoprene rubber material.

8. The system of claim 2, wherein the image sensor is integrated into a head-mounted display.

9. A system comprising at least one of:
an inertial measurement unit assembly system comprising:
a circuit board;
an inertial measurement unit coupled to the circuit board;
a frame; and
an isolation assembly disposed between the circuit board and the frame, the isolation assembly configured to reduce vibrations in least a portion of the circuit board adjacent to the inertial measurement unit; or
an additional system for a shock-absorbing head-mounted display comprising:
a head-mounted display;
an image sensor; and
a shock absorbing device, wherein the shock absorbing device comprises a shock absorbing material, the shock absorbing device is secured to the image sensor by an adhesive material, and the shock absorbing material is shaped and configured to partially surround the image sensor; or
a system for enhancing remote or virtual social experiences using biosignals comprising:
at least one physical processor and physical memory storing computer-executable instructions that, when executed by the physical processor, cause the physical processor to:
obtain biosignals from a first user;
obtain biosignals from a second user;
transform the biosignals of the first user into position information or force information for the first user's body;
transform the biosignals of the second user into position information or force information for the second user's body; and
update position information or force information for a virtual object based on at least one of the position information or the force information of the first user's body or the position information or the force information of the second user's body; or
an additional system for enhancing remote or virtual social experiences using biosignals comprising:
at least one additional physical processor and additional physical memory storing computer-executable instructions that, when executed by the additional physical processor, cause the additional physical processor to:
host a virtual environment for the first user and the second user, the virtual environment having at least one virtual object with which the first user and the second user simultaneously interact;
receive, while the first user and the second user interact with the at least one virtual object, position information or force information for the first user's body, the position information or the force information for the first user's body having been derived from biosignals obtained from the first user's body;
receive, while the first user and the second user interact with the at least one virtual object, position information or force information for the second user's body, the position information or the force information for the second user's body having been derived from biosignals obtained from the second user's body; and
update position information or force information for the at least one virtual object based on the position information or the force information of the first user's body and/or the position information or the force information of the second user's body; or
a system comprising a configurable device and a mount device comprising:
a physical memory storing configuration data associated with a location of the mount device;
a mounting portion for holding the configurable device; and
a communication module for communicatively coupling the mount device and the configurable device.

10. The system of claim 9, wherein the isolation assembly comprises one or more of:
a rigid piece; or
a compressible foam layer.

11. The system of claim 9, wherein the configuration data comprises at least one of a location name, location data, or application data.

12. The system of claim 9, wherein the configuration data comprises data for initializing the configurable device.

13. The system of claim 12, wherein the configuration data comprises data for initializing an application on the configurable device.

14. The system of claim 12, wherein the configuration data is static data.

15. The system of claim 9, wherein the communication module comprises an electrical connector.

16. The system of claim 15, wherein the electrical connector is integrated with the mounting portion.

17. The system of claim 16, wherein the mounting portion comprises spring fingers for connecting with the configurable device.

18. The system of claim 9, wherein the communication module comprises a wireless connection.

19. The system of claim 9, wherein the configurable device comprises at least one of a digital sign, a booking system, a wayfinder device, or a smart bus-stop sign.

20. The system of claim 9, wherein the configurable device comprises a non-removable battery.
